(19) United States
(12) Patent Application Publication
(10) Pub. No.: US 2009/0153289 A1
(43) Pub. Date: Jun. 18, 2009

(54) HANDHELD ELECTRONIC DEVICES WITH BIMODAL REMOTE CONTROL FUNCTIONALITY

(76) Inventors: Eric James Hope, Cupertino, CA (US); Alan Cannistraro, San Francisco, CA (US); Policarpo Wood, Cupertino, CA (US)

Correspondence Address: G. VICTOR TREYZ, 870 MARKET STREET, FLOOD BUILDING, SUITE 984, SAN FRANCISCO, CA, 94102, US

(21) Appl. No.: 11/955,385

(22) Filed: Dec. 12, 2007

(51) Int. Cl. G05B 19/00; G06F 3/048; G06F 3/041

(52) U.S. Cl. 340/5.1; 715/810; 345/173

(57) ABSTRACT

Handheld electronic devices are provided that have bimodal remote control functionality and gesture recognition features. The handheld electronic device may have gestural interface functionality in a first mode and graphical interface functionality in a second mode. The handheld electronic device may have remote control functionality in addition to cellular telephone, music player, or handheld computer functionality. The handheld electronic devices may have a touch sensitive display screen. The handheld electronic devices may recognize gestures performed by a user on the touch sensitive display screen. The handheld electronic devices may generate remote control signals from gestures that the handheld electronic device may recognize. A media system may receive the remote control signals and may take appropriate action. The touch sensitive display screen may be used to present the user with information about the media system such as listings of media on the media system and system parameters such as the current volume.

### BACKGROUND

This invention relates to handheld electronic devices, and more particularly, to handheld electronic devices that have multiple operating modes such as a gestural interface remote control mode and a graphical interface remote control mode.

Remote controls are commonly used for controlling televisions, set-top boxes, stereo receivers, and other consumer electronic devices. Remote controls have also been used to control appliances such as lights, window shades, and fireplaces.

Because of the wide variety of devices that use remote controls, universal remote controls have been developed. A universal remote control can be programmed to control more than one device. For example, a universal remote control may be configured to control both a television and a set-top box.

Conventional universal remote controls have a number of limitations. Conventional universal remote controls typically have a large number of buttons. It is therefore often difficult for a user to operate a conventional universal remote control device without focusing on the universal remote control device. This may lead to frustration as a user is forced to switch focus between pressing the correct button on the remote control and viewing information on a television or other device that is being controlled by the remote control.

Conventional remote controls are typically not able to present a user with a variety of complex media system remote control options. It is therefore common to rely on a television or other device to display this type of information for a user. This type of arrangement may be awkward for a user to remotely control a device that is not in the user's line of sight.

A conventional universal remote control device generally remains in the vicinity of the equipment it is used to operate. This is because conventional remote controls are typically dedicated to performing remote control functions for a particular device.

It would therefore be desirable to be able to provide a way in which to overcome the limitations of conventional remote controls.

### SUMMARY

In accordance with an embodiment of the present invention, a handheld electronic device with remote control functionality is provided. The handheld electronic device may have the ability to operate in two modes. In a gestural interface mode, the handheld electronic device may perform gesture recognition operations. In a graphical interface mode, the handheld electronic device may be used to navigate a graphical interface containing media system options retrieved from a media system.

The handheld electronic device may have remote control functionality as well as cellular telephone, music player, or handheld computer functionality. One or more touch sensitive displays may be provided on the device. For example, the device may have a touch screen that occupies most or all of the front face of the device. Bidirectional wireless communications circuitry may be used to support cellular telephone calls, wireless data services (e.g., 3G services), local wireless links (e.g., Wi-Fi® or Bluetooth® links), and other wireless functions. During remote control operations, the wireless communications circuitry may be used to convey remote control commands to a media system. Information from the media system may also be conveyed wirelessly to the handheld electronic device.

With one suitable arrangement, the touch sensitive display screen may recognize gestures that a user makes on the touch sensitive display screen. In a gestural interface mode, recognized gestures may be translated into media system user inputs by the device. In a graphical interface mode, recognized gestures or user input commands made using other user input arrangements may be used to navigate through a graphical interface of on-screen media system options displayed on the handheld electronic device.

The handheld electronic device may remotely control a media system using radio-frequency signals or infrared signals generated by the wireless communications circuitry. The media system user inputs derived from a user's gestures or other user input devices (e.g., buttons) may be used to generate appropriate remote control signals to remotely control a media system.

During operation of the handheld electronic device to control a media system, the media system may transmit signals to the handheld electronic device. For example, the media system may transmit data signals to the handheld electronic device that indicate the state of the media system. The state of the media system may reflect, for example, the current volume level, playback speed, title number, chapter number, elapsed time, and time remaining in a media playback operation of the media system.

As media system remote control gestures are supplied to the handheld electronic device in a gestural interface mode, the handheld electronic device may display confirmatory information on the display of the handheld electronic device. This confirmatory information may serve to inform the user that a gesture has been properly recognized. The confirmatory information may be displayed in a way that allows the user to monitor the confirmatory information using only peripheral vision or momentary glances at the display.

As media system remote control gestures or other user inputs are supplied to the handheld electronic device in a graphical interface mode, the handheld electronic device may be used to browse a set of menus retrieved from a media system. The menus may serve to organize the content stored on the media system for access by the handheld electronic device. The menus may be displayed by the handheld electronic device in a way that allows the user to operate the media system using only the information displayed on the handheld electronic device.

The handheld electronic device may include an orientation sensor (e.g., accelerometer). Processing circuitry in the device can use the orientation sensor to determine the orientation (e.g., the angle) of the device relative to horizontal. The device may be configured to automatically switch between the gestural interface mode and the graphical interface mode based on orientation information (e.g., the angle of the device related to horizontal) that is provided by the orientation sensor).

Further features of the invention, its nature and various advantages will be more apparent from the accompanying drawings and the following detailed description.

### BRIEF DESCRIPTION OF THE DRAWINGS

FIG. 1 is a diagram of an illustrative remote control environment in which a handheld electronic device with remote control functionality may be used in accordance with an embodiment of the present invention.

FIG. 2 is a perspective view of an illustrative remote control implemented in a handheld electronic device having a display in accordance with an embodiment of the present invention.

FIG. 3 is a schematic diagram of an illustrative remote control implemented in a handheld electronic device in accordance with an embodiment of the present invention.

FIG. 4 is a generalized schematic diagram of an illustrative media system that may be controlled by a handheld electronic device with remote control functionality in accordance with an embodiment of the present invention.

FIG. 5 is a schematic diagram of an illustrative media system based on a personal computer that may be controlled by a handheld electronic device with remote control functionality in accordance with an embodiment of the present invention.

FIG. 6 is a schematic diagraph of an illustrative media system based on consumer electronic equipment such as a television, set-top box, and audio-video receiver that may be controlled by a handheld electronic device with remote control functionality in accordance with an embodiment of the present invention.

FIG. 7 is an illustrative main menu display screen that may be displayed by a media system that is controlled by a handheld electronic device that includes remote control capabilities in accordance with an embodiment of the present invention.

FIG. 8 is an illustrative now playing display screen that may be displayed by a media system that is controlled by a handheld electronic device with remote control capabilities in accordance with an embodiment of the present invention.

FIG. 9 is an illustrative display screen that may be displayed by a media application that includes a list of songs or other selectable media items and that may be controlled by a handheld electronic device with remote control capabilities in accordance with an embodiment of the present invention.

FIG. 10 is a state diagram of illustrative operational modes for a remote control implemented in a handheld electronic device in accordance with an embodiment of the present invention.

FIG. 11 is an illustrative homepage screen that may be displayed by a handheld electronic device with remote control capabilities in accordance with an embodiment of the present invention.

FIG. 12 is an illustrative media system remotes screen that may be displayed by a handheld electronic device with remote control capabilities in accordance with an embodiment of the present invention.

FIG. 13 is an illustrative media system remote add process screen that may be displayed by a handheld electronic device with remote control capabilities in accordance with an embodiment of the present invention.

FIG. 14 is an illustrative media system remote add process screen that may be displayed by a handheld electronic device with remote control capabilities in accordance with an embodiment of the present invention.

FIG. 15 is an illustrative media system remote edit process screen that may be displayed by a handheld electronic device with remote control capabilities in accordance with an embodiment of the present invention.

FIG. 16 is an illustrative media system remote edit process screen that may be displayed by a handheld electronic device with remote control capabilities in accordance with an embodiment of the present invention.

FIG. 17 is an illustrative media system remote screen that may be displayed by a handheld electronic device with remote control capabilities in accordance with an embodiment of the present invention.

FIG. 18 is an illustrative media system remote now playing screen that may be displayed by a handheld electronic device with remote control capabilities in accordance with an embodiment of the present invention.

FIG. 19 is an illustrative global footer in a media system remote screen that may be displayed by a handheld electronic device with remote control capabilities in accordance with an embodiment of the present invention.

FIG. 20 is a flow chart of illustrative steps involved in using a handheld electronic device with a touch screen display to receive and process media system remote control gestures for a media system in a gestural interface mode in accordance with an embodiment of the present invention.

FIG. 21 is a flow chart of illustrative steps involved in using a handheld electronic device with a touch screen display to receive and process user input for a media system in a graphical interface mode in accordance with an embodiment of the present invention.

FIG. 22 is a side view of an illustrative remote control implemented in a handheld electronic device showing how the orientation of the device relative to horizontal may be determined in accordance with an embodiment of the present invention.

FIG. 23 is a graph of illustrative bimodal switching behavior that maybe associated with a remote control implemented in a handheld electronic device in accordance with an embodiment of the present invention.

FIG. 24 is a flow chart of illustrative steps involved in using a handheld electronic device with bimodal remote control functionality and a touch screen display to receive and process media system remote control commands for a media system in accordance with an embodiment of the present invention.

FIG. 24 is a flow chart of illustrative steps involved in automatically configuring a handheld electronic device with an orientation sensor and bimodal remote control functionality in either a graphical user interface mode or a gestural user interface mode in accordance with an embodiment of the present invention.

### DETAILED DESCRIPTION

The present invention relates generally to handheld electronic devices that have been configured to function as remote control devices and, more particularly, to remote control devices that switch between a gestural interface mode and a graphical interface mode. The handheld devices may be dedicated remote controls or may be more general-purpose handheld electronic devices that have been configured by loading remote control software applications, by incorporating remote control support into the operating system or other software on the handheld electronic devices, or by using a combination of software and/or hardware to implement remote control features. Handheld electronic devices that have been configured to support media system remote control functions are sometimes referred to herein as remote control devices.

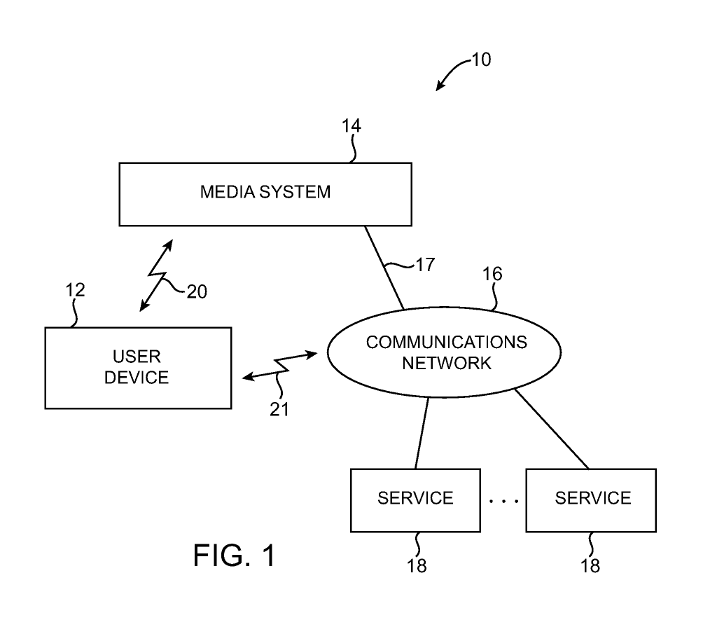

An illustrative environment in which a remote control device may operate in accordance with the present invention is shown in FIG. 1. Users in environment 10 may have user device 12. User device 12 may be used to control media system 14 over communications path 20. User device 12, media system 14, and services 18 may be connected through a communications network 16. User device 12 may connect to communications network 16 through communications path 21. In one embodiment of the invention, user device 12 may be used to control media system 14 through the communications network 16. User device 12 may also be used to control media system 14 directly.

User device 12 may have any suitable form factor. For example, user device 12 may be provided in the form of a handheld device, desktop device, or even integrated as part of a larger structure such as a table or wall. With one particularly suitable arrangement, which is sometimes described herein as an example, user device 12 may be provided with a handheld form factor. For example, device 12 may be a handheld electronic device. Illustrative handheld electronic devices that may be provided with remote control capabilities include cellular telephones, media players with wireless communications capabilities, handheld computers (also sometimes called personal digital assistants), dedicated remote control devices, global positioning system (GPS) devices, handheld gaming devices, and other handheld devices. If desired, user device 12 may be a hybrid device that combines the functionality of multiple conventional devices. Examples of hybrid handheld devices include a cellular telephone that includes media player functionality, a gaming device that includes a wireless communications capability, a cellular telephone that includes game and email functions, and a handheld device that receives email, supports mobile telephone calls, supports web browsing, and includes media player functionality. These are merely illustrative examples.

Media system 14 may be any suitable media system such as a system that includes one or more televisions, cable boxes (e.g., a cable set-top box receiver), handheld electronic devices with wireless communications capabilities, media players with wireless communications capabilities, satellite receivers, set-top boxes, personal computers, amplifiers, audio-video receivers, digital video recorders, personal video recorders, video cassette recorders, digital video disc (DVD) players and recorders, and other electronic devices. If desired, system 14 may include non-media devices that are controllable by a remote control device such as user device 12. For example, system 14 may include remotely controlled equipment such as home automation controls, remotely controlled light fixtures, door openers, gate openers, car alarms, automatic window shades, and fireplaces.

Communications path 17 (and the other paths in system 10) such as path 20 between device 12 and system 14, path 21 between device 12 and network 16, and the paths between network 16 and services 18 may be used to handle video, audio, and data signals. Communications paths in system 10 such as path 17 and the other paths in FIG. 1 may be based on any suitable wired or wireless communications technology. For example, the communications path in system 10 may be based on wired communications technology such as coaxial cable, copper wiring, fiber optic cable, universal serial bus (USB®), IEEE 1394 (FireWire®), paths using serial protocols, paths using parallel protocols, and Ethernet paths. Communications paths in system 10 may, if desired, be based on wireless communications technology such as satellite technology, television broadcast technology, radio-frequency (RF) technology, wireless universal serial bus technology, Wi-Fi® or Bluetooth® technology 802.11 wireless link technology. Wireless communications paths in system 10 may also include cellular telephone bands such as those at 850 MHz, 900 MHz, 1800 MHz, and 1900 MHz (e.g., the main Global System for Mobile Communications or GSM cellular telephone bands), one or more proprietary radio-frequency links, and other local and remote wireless links. Communications paths in system 10 may be based on wireless signals sent using light (e.g., using infrared communications). Communications paths in system 10 may be based on wireless signals sent using sound (e.g., using acoustic communications).

Communications path 20 may be used for one-way or two-way transmissions between user device 12 and media system 14. For example, user device 12 may transmit remote control signals to media system 14 to control the operation of media system 14. If desired, media system 14 may transmit data signals to user device 12. System 14 may, for example, transmit information to device 12 that informs device 12 of the current state of system 14. As an example, media system 14 may transmit information about a particular equipment or software state such as the current volume setting of a television or media player application or the current playback speed of a media item being presented using a media playback application or a hardware-based player.

Communications network 16 may be based on any suitable communications network or networks such as a radio-frequency network, the Internet, an Ethernet network, a wireless network, a Wi-Fi® network, a Bluetooth® network, a cellular telephone network, or a combination of such networks.

Services 18 may include television and media services. For example, services 18 may include cable television providers, television broadcast services (e.g., television broadcasting towers), satellite television providers, email services, media servers (e.g., servers that supply video, music, photos, etc.), media sharing services, media stores, programming guide services, software update providers, game networks, etc. Services 18 may communicate with media system 14 and user device 12 through communications network 16.

In a typical scenario, media system 14 is used by a user to view media. For example, media system 14 may be used to play compact disks, video disks, tapes, and hard-drive-based or flash-disk-based media files. The songs, videos, and other content may be presented to the user using speakers and display screens. In a typical scenario, visual content such as a television program that is received from a cable provider may be displayed on a television. Audio content such as a song may be streamed from an on-line source or may be played back from a local hard-drive. These are merely illustrative examples. Users may interact with a variety of different media types in any suitable formats using software-based and/or hardware-based media playback equipment.

The equipment in media system 14 may be controlled by conventional remote controls (e.g., dedicated infrared remote controls that are shipped with the equipment). The equipment in media system 14 may also be controlled using user device 12. User device 12 may have a touch screen that allows device 12 to recognize touch based inputs such as gestures. Media system remote control functionality may be implemented on device 12 (e.g., using software and/or hardware in device 12). The remote control functionality may, if desired, be provided in addition to other functions. For example, the media system remote control functionality may be implemented on a device that normally functions as a music player, cellular telephone, or hybrid music player and cellular telephone device (as examples). With this type of arrangement, a user may use device 12 for a variety of media and communications functions when the user carries device 12 away from system 14. When the user brings device 12 into proximity of system 14 or when a user desires to control system 14 remotely (e.g., through a cellular telephone link or other remote network link), the remote control capabilities of device 12 may be used to control system 14. In a typical configuration, a user views video content or listens to audio content (herein collectively “views content”) while seated in a room that contains at least some of the components of system 14 (e.g., a display and speakers).

The ability of user device 12 to recognize touch screen-based remote control commands allows device 12 to provide remote control functionality without requiring dedicated remote control buttons. Dedicated buttons on device 12 may be used to help control system 14 if desired, but in general such buttons are not needed. The remote control interface aspect of device 12 therefore need not interfere with the normal operation of device 12 for non-remote-control functions (e.g., accessing email messages, surfing the web, placing cellular telephone calls, playing music, etc.). Another advantage to using a touch screen-based remote control interface for device 12 is that touch screen-based remote control interfaces are relatively uncluttered.

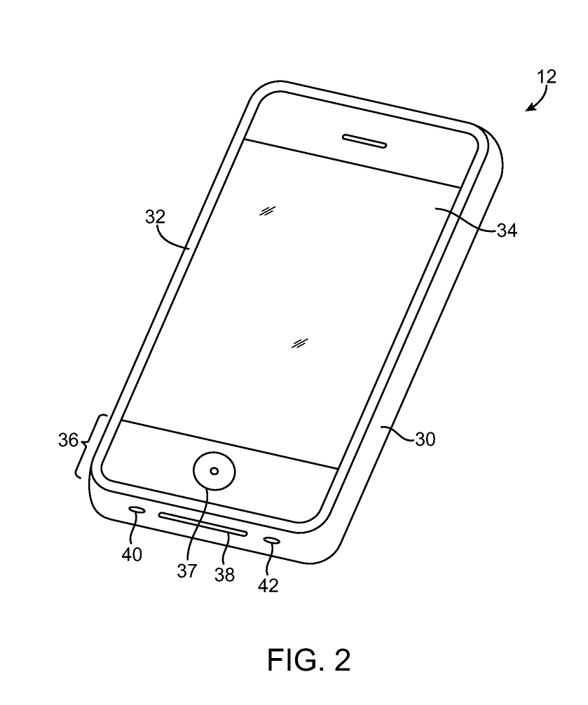

An illustrative user device 12 in accordance with an embodiment of the present invention is shown in FIG. 2. User device 12 may be any suitable portable or handheld electronic device.

User device 12 may include one or more antennas for handling wireless communications. If desired, an antenna in device 12 may be shared between multiple radio-frequency transceivers (radios). There may also be one or more dedicated antennas in device 12 (e.g., antennas that are each associated with a respective radio).

User device 12 may handle communications over one or more communications bands. For example, in a user device such as user device 12 with two antennas, a first of the two antennas may be used to handle cellular telephone and data communications in one or more frequency bands, whereas a second of the two antennas may be used to handle data communications in a separate communications band. With one suitable arrangement, which is sometimes described herein as an example, the second antenna may be shared between two or more transceivers. With this type of arrangement, the second antenna may be configured to handle data communications in a communications band centered at 2.4 GHz. A first transceiver may be used to communicate using the Wi-Fi® (IEEE 802.11) band at 2.4 GHz and a second transceiver may be used to communicate using the Bluetooth® band at 2.4 GHz. To minimize device size and antenna resources, the first transceiver and second transceiver may share a common antenna.

In configurations with multiple antennas, the antennas may be designed to reduce interference so as to allow the two antennas to operate in relatively close proximity to each other. For example, in a configuration in which one antenna is used to handle cellular telephone bands (and optional additional bands) and in which another antenna is used to support shared Wi-Fi/Bluetooth communications, the antennas may be configured to reduce interference with each other.

Device 12 may have a housing 30. Housing 30, which is sometimes referred to as a case, may be formed of any suitable materials including, plastic, glass, ceramics, metal, or other suitable materials, or a combination of these materials. In some situations, housing 30 or portions of housing 30 may be formed from a dielectric or other low-conductivity material, so that the operation of conductive antenna elements that are located in proximity to housing 30 is not disrupted.

Housing 30 or portions of housing 30 may also be formed from conductive materials such as metal. An illustrative conductive housing material that may be used is anodized aluminum. Aluminum is relatively light in weight and, when anodized, has an attractive insulating and scratch-resistant surface. If desired, other metals can be used for the housing of user device 12, such as stainless steel, magnesium, titanium, alloys of these metals and other metals, etc. In scenarios in which housing 30 is formed from metal elements, one or more of the metal elements may be used as part of the antennas in user device 12. For example, metal portions of housing 30 may be shorted to an internal ground plane in user device 12 to create a larger ground plane element for that user device 12.

Housing 30 may have a bezel 32. The bezel 32 may be formed from a conductive material such as stainless steel. Bezel 32 may serve to hold a display or other device with a planar surface in place on user device 12. As shown in FIG. 2, for example, bezel 32 may be used to hold display 34 in place by attaching display 34 to housing 30. User device 12 may have front and rear planar surfaces. In the example of FIG. 2, display 34 is shown as being formed as part of the planar front surface of user device 12.

Display 34 may be a liquid crystal diode (LCD) display, an organic light emitting diode (OLED) display, or any other suitable display. The outermost surface of display 34 may be formed from one or more plastic or glass layers. If desired, touch screen functionality may be integrated into display 34 or may be provided using a separate touch pad device. An advantage of integrating a touch screen into display 34 to make display 34 touch sensitive is that this type of arrangement can save space and reduce visual clutter. Arrangements in which display 34 has touch screen functionality may also be particularly advantageous when it is desired to control media system 14 using gesture-based commands.

Display 34 may have a touch screen layer and a display layer. The display layer may have numerous pixels (e.g., thousands, tens of thousands, hundreds of thousands, millions, or more) that may be used to display a graphical user interface (GUI). The touch layer may be a clear panel with a touch sensitive surface positioned in front of a display screen so that the touch sensitive surface covers the viewable area of the display screen. The touch panel may sense touch events (e.g., user input) at the x and y coordinates on the touch screen layer where a user input is made (e.g., at the coordinates where the user touches display 34). The touch screen layer may be used in implementing multi-touch capabilities for user device 12 in which multiple touch events can be simultaneously received by display 34. Multi-touch capabilities may allow for more complex user inputs on touch screen display 34. The touch screen layer may be based on touch screen technologies such as resistive, capacitive, infrared, surface acoustic wave, electromagnetic, near field imaging, etc.

Display screen 34 (e.g., a touch screen) is merely one example of an input-output device that may be used with user device 12. If desired, user device 12 may have other input-output devices. For example, user device 12 may have user input control devices such as button 37, and input-output components such as port 38 and one or more input-output jacks (e.g., for audio and/or video). Button 37 may be, for example, a menu button. Port 38 may contain a 30-pin data connector (as an example). Openings 42 and 40 may, if desired, form microphone and speaker ports. Suitable user input interface devices for user device 12 may also include buttons such as alphanumeric keys, power on-off, power-on, power-off, and other specialized buttons, a touch pad, pointing stick, or other cursor control device, a microphone for supplying voice commands, or any other suitable interface for controlling user device 12. In the example of FIG. 2, display screen 34 is shown as being mounted on the front face of user device 12, but display screen 34 may, if desired, be mounted on the rear face of user device 12, on a side of user device 12, on a flip-up portion of user device 12 that is attached to a main body portion of user device 12 by a hinge (for example), or using any other suitable mounting arrangement.

Although shown schematically as being formed on the top face of user device 12 in the example of FIG. 2, buttons such as button 37 and other user input interface devices may generally be formed on any suitable portion of user device 12. For example, a button such as button 37 or other user interface control may be formed on the side of user device 12. Buttons and other user interface controls can also be located on the top face, rear face, or other portion of user device 12. If desired, user device 12 can be controlled remotely (e.g., using an infrared remote control, a radio-frequency remote control such as a Bluetooth remote control, etc.)

User device 12 may have ports such as port 38. Port 38, which may sometimes be referred to as a dock connector, 30-pin data port connector, input-output port, or bus connector, may be used as an input-output port (e.g., when connecting user device 12 to a mating dock connected to a computer or other electronic device). User device 12 may also have audio and video jacks that allow user device 12 to interface with external components. Typical ports include power jacks to recharge a battery within user device 12 or to operate user device 12 from a direct current (DC) power supply, data ports to exchange data with external components such as a personal computer or peripheral, audio-visual jacks to drive headphones, a monitor, or other external audio-video equipment, a subscriber identity module (SIM) card port to authorize cellular telephone service, a memory card slot, etc. The functions of some or all of these devices and the internal circuitry of user device 12 can be controlled using input interface devices such as touch screen display 34.

Components such as display 34 and other user input interface devices may cover most of the available surface area on the front face of user device 12 (as shown in the example of FIG. 2) or may occupy only a small portion of the front face of user device 12.

With one suitable arrangement, one or more antennas for user device 12 may be located in the lower end 36 of user device 12, in the proximity of port 38. An advantage of locating antennas in the lower portion of housing 30 and user device 12 is that this places the antennas away from the user's head when the user device 12 is held to the head (e.g., when talking into a microphone and listening to a speaker in the user device as with a cellular telephone). This may reduce the amount of radio-frequency radiation that is emitted in the vicinity of the user and may minimize proximity effects.

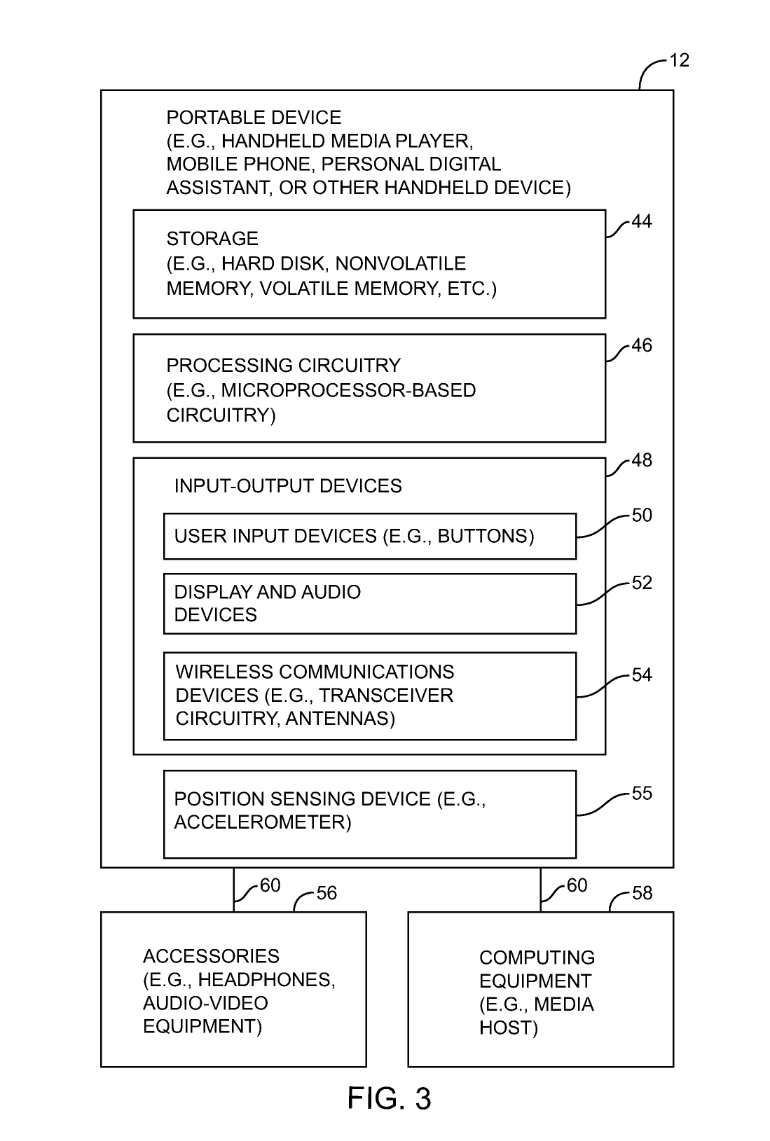

A schematic diagram of an embodiment of an illustrative user device 12 is shown in FIG. 3. User device 12 may be a mobile telephone, a mobile telephone with media player capabilities, a handheld computer, a remote control, a game player, a global positioning system (GPS) device, a combination of such devices, or any other suitable portable electronic device.

As shown in FIG. 3, user device 12 may include storage 44. Storage 44 may include one or more different types of storage such as hard disk drive storage, nonvolatile memory (e.g., flash memory or other electrically-programmable-read-only memory), volatile memory (e.g., battery-based static or dynamic random-access-memory), etc.

Processing circuitry 46 may be used to control the operation of user device 12. Processing circuitry 46 may be based on a processor such as a microprocessor and other suitable integrated circuits. With one suitable arrangement, processing circuitry 46 and storage 44 are used to run software on user device 12, such as remote control applications, internet browsing applications, voice-over-internet-protocol (VOIP) telephone call applications, email applications, media playback applications, operating system functions (e.g., operating system functions supporting remote control capabilities), etc. Processing circuitry 46 and storage 44 may be used in implementing communications protocols for device 12. Communications protocols that may be implemented using processing circuitry 46 and storage 44 include internet protocols, wireless local area network protocols (e.g., IEEE 802.11 protocols, protocols for other short-range wireless communications links such as the Bluetooth® protocol, infrared communications, etc.), and cellular telephone protocols.

Input-output devices 48 may be used to allow data to be supplied to user device 12 and to allow data to be provided from user device 12 to external devices. Display screen 34, button 37, microphone port 42, speaker port 40, and dock connector port 38 are examples of input-output devices 48.

Input-output devices 48 can include user input output devices 50 such as buttons, touch screens, joysticks, click wheels, scrolling wheels, touch pads, key pads, keyboards, microphones, cameras, etc. A user can control the operation of user device 12 by supplying commands through user input devices 50. Display and audio devices 52 may include liquid-crystal display (LCD) screens or other screens, light-emitting diodes (LEDs), and other components that present visual information and status data. Display and audio devices 52 may also include audio equipment such as speakers and other devices for creating sound. Display and audio devices 52 may contain audio-video interface equipment such as jacks and other connectors for external headphones and monitors.

Wireless communications devices 54 may include communications circuitry such as radio-frequency (RF) transceiver circuitry formed from one or more integrated circuits, power amplifier circuitry, passive RF components, one or more antennas, and other circuitry for handling RF wireless signals. Wireless signals can also be sent using light (e.g., using infrared communications circuitry in circuitry 54).

Orientation sensing device 55 may include orientation sensing devices such as an accelerometer or other device that can determine the orientation of the user device 12 relative to horizontal (i.e., relative to a plane perpendicular to the vertical direction defined by the force of gravity).

User device 12 can communicate with external devices such as accessories 56 and computing equipment 58, as shown by paths 60. Paths 60 may include wired and wireless paths (e.g., bidirectional wireless paths). Accessories 56 may include headphones (e.g., a wireless cellular headset or audio headphones) and audio-video equipment (e.g., wireless speakers, a game controller, or other equipment that receives and plays audio and video content).

Computing equipment 58 may be any suitable computer. With one suitable arrangement, computing equipment 58 is a computer that has an associated wireless access point (router) or an internal or external wireless card that establishes a wireless connection with user device 12. The computer may be a server (e.g., an internet server), a local area network computer with or without internet access, a user's own personal computer, a peer device (e.g., another user device 12), or any other suitable computing equipment. Computing equipment 58 may be associated with one or more services such as services 18 of FIG. 1. A link such as link 60 may be used to connect device 12 to a media system such as media system 14 (FIG. 1)

Wireless communications devices 54 may be used to support local and remote wireless links.

Examples of local wireless links include infrared communications, Wi-Fi®, Bluetooth®, and wireless universal serial bus (USB) links. Because wireless Wi-Fi links are typically used to establish data links with local area networks, links such as Wi-Fi® links are sometimes referred to as WLAN links. The local wireless links may operate in any suitable frequency band. For example, WLAN links may operate at 2.4 GHz or 5.6 GHz (as examples), whereas Bluetooth links may operate at 2.4 GHz. The frequencies that are used to support these local links in user device 12 may depend on the country in which user device 12 is being deployed (e.g., to comply with local regulations), the available hardware of the WLAN or other equipment with which user device 12 is connecting, and other factors. An advantage of incorporating WLAN capabilities into wireless communications devices 54 is that WLAN capabilities (e.g., Wi-Fi capabilities) are widely deployed. The wide acceptance of such capabilities may make it possible to control a relatively wide range of media equipment in media system 14.

If desired, wireless communications devices 54 may include circuitry for communicating over remote communications links. Typical remote link communications frequency bands include the cellular telephone bands at 850 MHz, 900 MHz, 1800 MHz, and 1900 MHz, the global positioning system (GPS) band at 1575 MHz, and data service bands such as the 3G data communications band at 2170 MHz band (commonly referred to as UMTS or Universal Mobile Telecommunications System). In these illustrative remote communications links, data is transmitted over links 60 that are one or more miles long, whereas in short-range links 60, a wireless signal is typically used to convey data over tens or hundreds of feet.

These are merely illustrative communications bands over which wireless devices 54 may operate. Additional local and remote communications bands are expected to be deployed in the future as new wireless services are made available. Wireless devices 54 may be configured to operate over any suitable band or bands to cover any existing or new services of interest. If desired, multiple antennas and/or a broadband antenna may be provided in wireless devices 54 to allow coverage of more bands.

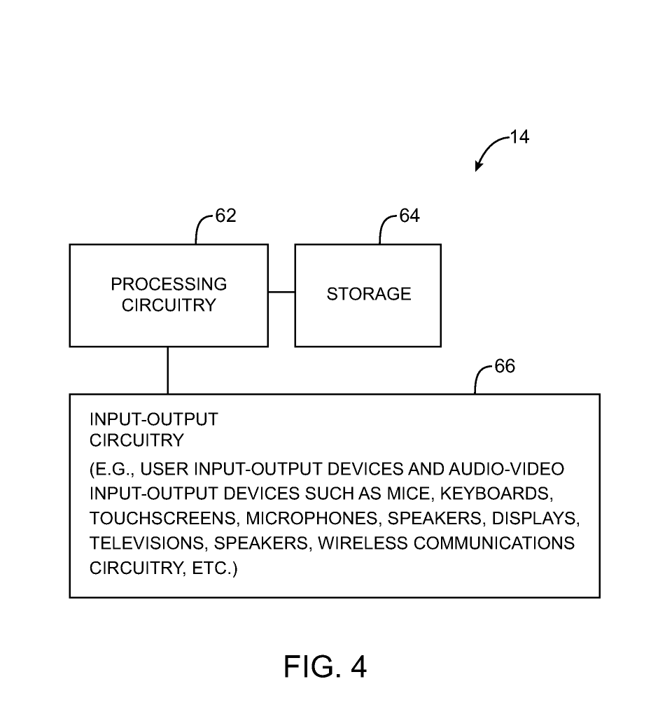

A schematic diagram of an embodiment of an illustrative media system is shown in FIG. 4. Media system 14 may include any suitable media equipment such as televisions, cable boxes (e.g., a cable receiver), handheld electronic devices with wireless communications capabilities, media players with wireless communications capabilities, satellite receivers, set-top boxes, personal computers, amplifiers, audio-video receivers, digital video recorders, personal video recorders, video cassette recorders, digital video disc (DVD) players and recorders, other electronic devices. System 14 may also include home automation controls, remote controlled light fixtures, door openers, gate openers, car alarms, automatic window shades, and fireplaces.

As shown in FIG. 4, media system 14 may include storage 64. Storage 64 may include one or more different types of storage such as hard disk drive storage, nonvolatile memory (e.g., flash memory or other electrically-programmable-read-only memory), volatile memory (e.g., battery-based static or dynamic random-access-memory), etc.

Processing circuitry 62 may be used to control the operation of media system 14. Processing circuitry 62 may be based on one or more processors such as microprocessors, microcontrollers, digital signal processors, application specific integrated circuits, and other suitable integrated circuits. With one suitable arrangement, processing circuitry 62 and storage 64 are used to run software on media system 14, such as a remote control applications, media playback applications, television tuner applications, radio tuner applications (e.g., for FM and AM tuners), file server applications, operating system functions, and presentation programs (e.g., a slide show).

Input-output circuitry 66 may be used to allow user input and data to be supplied to media system 14 and to allow user input and data to be provided from media system 14 to external devices. Input-output circuitry 66 can include user input-output devices and audio-video input-output devices such as mice, keyboards, touch screens, microphones, speakers, displays, televisions, speakers, and wireless communications circuitry.

Suitable communications protocols that may be implemented as part of input-output circuitry 66 include internet protocols, wireless local area network protocols (e.g., IEEE 802.11 protocols), protocols for other short-range wireless communications links such as the Bluetooth® protocol, protocols for handling 3G data services such as UMTS, cellular telephone communications protocols, etc.

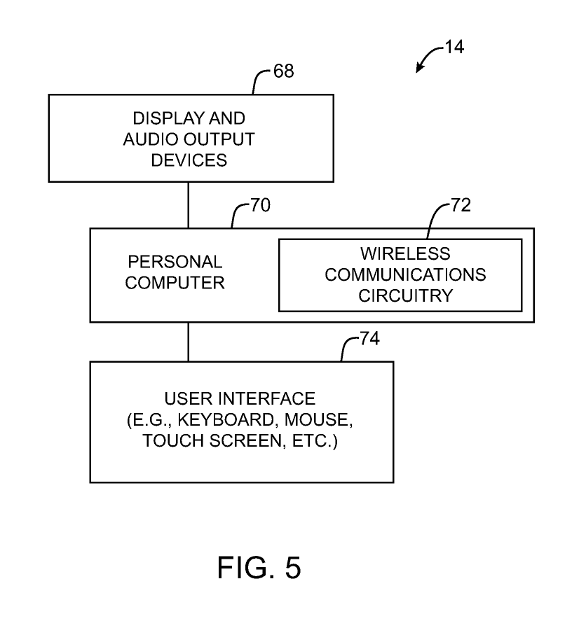

A schematic diagram of an embodiment of an illustrative media system that includes a computer is shown in FIG. 5. In the embodiment shown in FIG. 5, media system 14 may be based on a personal computer such as personal computer 70. Personal computer 70 may be any suitable personal computer 70 such as a personal desktop computer, a laptop computer, a computer that is used to implement media control functions (e.g., as part of a set-top box), a server, etc.

As shown in FIG. 5, personal computer 70 may include display and audio output devices 68. Display and audio output devices 68 may include one or more different types of display and audio output devices such as computer monitors, televisions, projectors, speakers, headphones, and audio amplifiers.

Personal computer 70 may include user interface 74. User interface 74 may include devices such as keyboards, mice, touch screens, trackballs, etc.

Personal computer 70 may include wireless communications circuitry 72. Wireless communications circuitry 72 may be used to allow user input and data to be supplied to personal computer 70 and to allow user input and data to be provided from personal computer 70 to external devices. Wireless communications circuitry 72 may implement suitable communications protocols. Suitable communications protocols that may be implemented as part of wireless communications circuitry 72 include internet protocols, wireless local area network protocols (e.g., IEEE 802.11 protocols—sometimes referred to as Wi-Fi®), protocols for other short-range wireless communications links such as the Bluetooth® protocol, protocols for handling 3G data services such as UMTS, cellular telephone communications protocols, etc. Wireless communications circuitry 72 may be provided using a transceiver that is mounted on the same circuit board as other components in computer 70, may be provided using a plug-in card (e.g., a PCI card), or may be provided using external equipments (e.g., a wireless universal serial bus adapter). Wireless communications circuitry 72 may, if desired, include infrared communications capabilities (e.g., to receive IR commands from device 12).

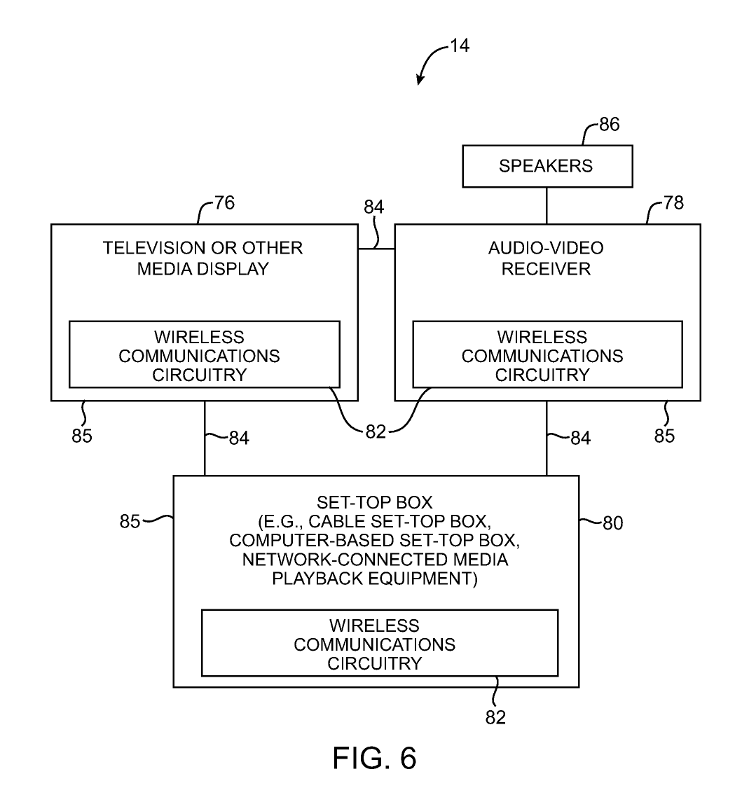

FIG. 6 is a schematic diagram of an illustrative media system that is based on consumer electronics devices in accordance with an embodiment of the present invention. In the embodiment of FIG. 6, media system 14 may include one or more media system components (sometimes called systems) such as media system 76, media system 78, and media system 80.

As shown in FIG. 6, media system 76 may be a television or other media display, media system 78 may be an audio-video receiver connected to speakers 86, and media system 80 may be a set-top box (e.g., a cable set-top box, a computer-based set-top box, network-connected media playback equipment of the type that can play wirelessly streamed media files through an audio-video receiver such as receiver 78, etc.).

Media system 76 may be a television or other media display. For example, media system 76 may be display such as a high-definition television, plasma screen, liquid crystal display (LCD), organic light emitting diode (OLED) display, etc. Television 76 may include a television tuner. A user may watch a desired television program by using the tuner to tune to an appropriate television channel. Television 76 may have integrated speakers. Using remote control commands, a user of television 76 may perform functions such as changing the current television channel for the tuner or adjusting the volume produced by the speakers in television 76.

Media system 78 may be an audio-video receiver. For example, media system 78 may be a receiver that has the ability to switch between various video and audio inputs. Media system 78 may be used to amplify audio signals for playback over speakers 86. Audio that is to be amplified by system 78 may be provided in digital or analog form from television 76 and media system 80.

Media system 80 may be a set-top box. For example, media system 80 may be a cable receiver, computer-based set-top box, network-connected media playback equipment, personal video recorder, digital video recorder, etc.

Media systems 76, 78, and 80 may be interconnected via paths 84. Paths 84 may be based on any suitable wired or wireless communication technology. In one embodiment, audio-video receiver 78 may receive audio signals from television 76 and set-top box 80 via paths 84. These audio signals may be provided as digital signals or analog signals. Receiver 78 may amplify the received audio signals and may provide corresponding amplified output to speakers 86. Set-top box 80 may supply video and audio signals to the television 76 and may supply video and audio signals to audio-video receiver 78. Set-top box 80 may, for example, receive television signals from a television provider on a television signal input line. A tuner in set-top box 80 may be used to tune to a desired television channel. A video and audio signal corresponding to this channel may be supplied to television 76 and receiver 78. Set-top box 80 may also supply recorded content (e.g., content that has been recorded on a hard-drive), downloaded content (e.g., video and audio files that have been downloaded from the Internet, etc.)

If desired, television 76 may send video and audio signals to a digital video recorder (set-top box 80) while simultaneously sending audio to audio-video receiver 78 for playback over speakers 86. These examples are merely illustrative as the media system components of FIG. 6 may be interconnected in any suitable manner.

Media system components 76, 78, and 80 may include wireless communications circuitry 82. Wireless communications circuitry 82 may be used to allow user input and other information to be exchanged between media systems 76, 78, and 80, user device 12, and services 18. Wireless communications circuitry 82 may be used to implement one or more communications protocols. Suitable communications protocols that may be implemented as part of wireless communications circuitry 82 include internet protocols, wireless local area network protocols (e.g., IEEE 802.11 protocols), protocols for other short-range wireless communications links such as the Bluetooth® protocol, protocols for handling 3G data services such as UMTS, cellular telephone communications protocols, etc.

Media systems 76, 78, and 80 may also exchange user input and data through paths such as paths 84. Paths 84 may be wireless or wired paths. If one or more of media systems 76, 78, and 80 is inaccessible to user device 12 by communications path 20 (FIG. 1), then any media system 76, 78, or 80 that has access to user device 12 through communications path 20 may form a bridge, using one of paths 84, between user device 12 and any media systems that do not have direct access to user device 12 via communications path 20.

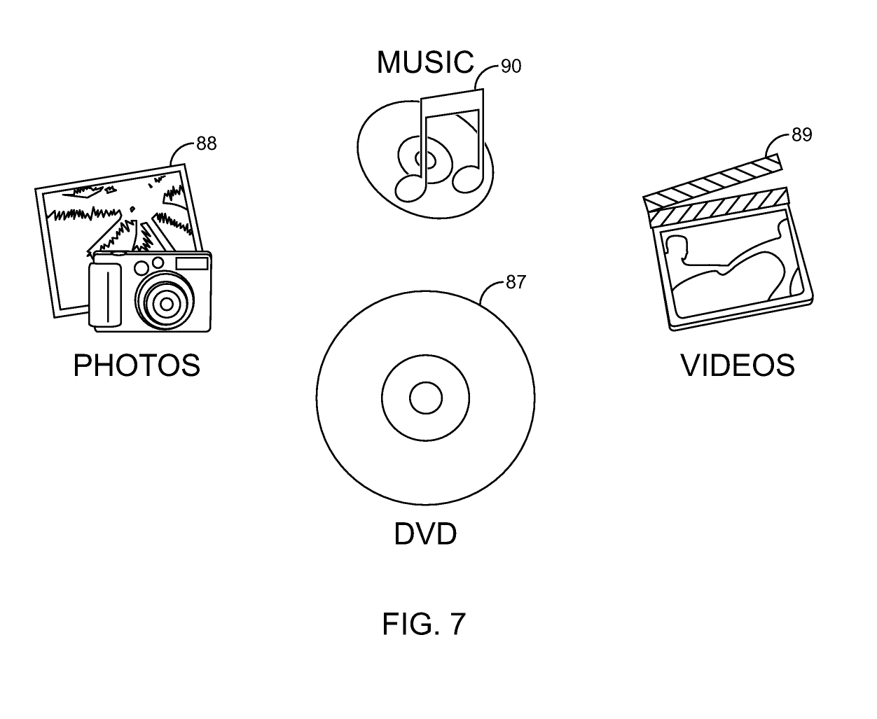

FIG. 7 shows an illustrative menu display screen that may be provided by media system 14. Media system 14 may present the menu screen of FIG. 7 when the user has a selection of various media types available. In the example of FIG. 7, the selectable media types include DVD 87, photos 88, videos 89, and music 90. This is merely illustrative. Any suitable menu options may be presented with media system 14 to allow a user to choose between different available media types, to select between different modes of operation, to enter a setup mode, etc.

User device 12 may be used to browse through the selectable media options that are presented by media system 14. User device 12 may also be used to select a media option. For example, user device 12 may wirelessly send commands to media system 14 through path 20 that direct media system 14 to move through selectable media options. When moving through selectable media options, each possible selection may rotate to bring a new media option to the forefront (i.e., a prominent central location of the display). In this type of configuration, user device 12 may send user input to media system 14 through path 20 to select the media option that is currently highlighted (i.e., the option that is displayed at the bottom in the FIG. 7 example). If desired, user device 12 may send commands to media system 14 through path 20 to select any of the displayed selectable media options without first scrolling through a set of available options to visually highlight a particular option.

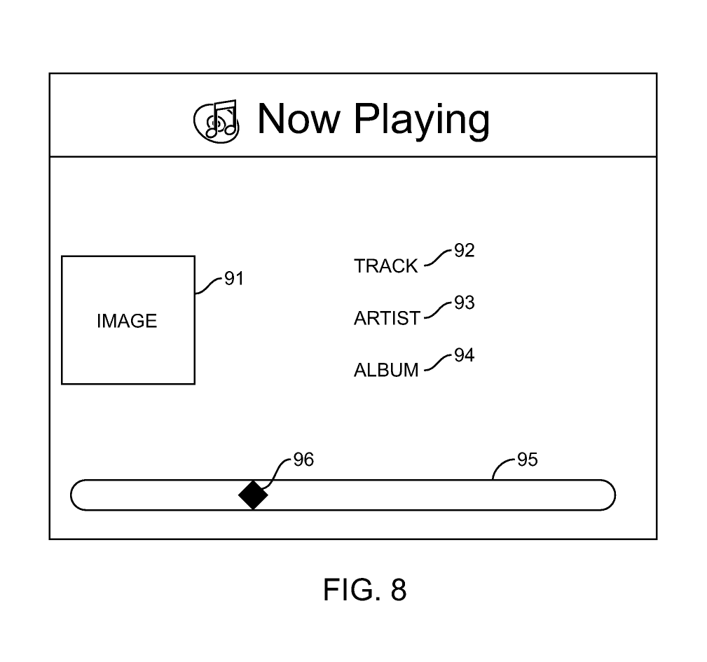

FIG. 8 shows an illustrative now playing display screen that may be presented to a user by media system 14. Media system 14 may present the now playing screen of FIG. 8 when media system 14 is performing a media playback operation. For example, when media system 14 is playing an audio track, media system 14 may display a screen with an image 91 (e.g., album art), progress bar 95, progress indicator 96, and track information such as the audio track name 92, artist name 93, and album name 94.

User device 12 may be used to perform remote control functions during the playback of an audio (or video) track (e.g., when media system 14 is displaying a now playing screen of the type shown in FIG. 8) and when audio (or video) information is being presented to the user (e.g., through speakers or a display in system 14). For example, user device 12 may send user input commands to media system 14 through path 20 to increase or decrease a volume setting, to initiate a play operation, pause operation, fast forward operation, rewind operation, or skip tracks operation.

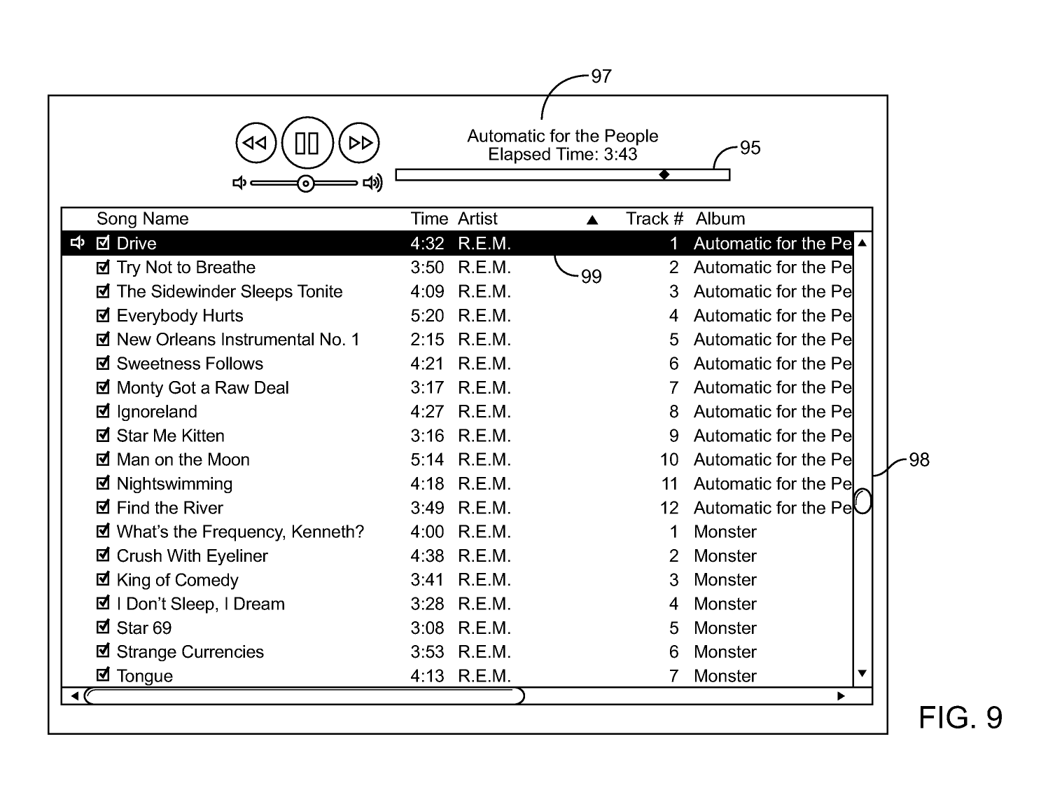

FIG. 9 shows an illustrative display screen associated with a media application running on media system 14. Media system 14 may use a media application to present the list of available media items in the screen of FIG. 9 when media system 14 is performing a media playback operation or when a user is interested in selecting songs, videos, or other media items for inclusion in a playlist. For example, when media system 14 is playing an audio track, media system 14 may display a screen with track information 97, progress bar 95, track listing region 98, and information on the currently highlighted track 99.

User device 12 may be used to remotely control the currently playing audio track listed in track information region 97. With this type of arrangement, user device 12 may send commands to media system 14 through path 20 to increase or decrease volume, play, pause, fast forward, rewind, or skip tracks. User device 12 may also perform remote control functions on the track listings 98. For example, user device 12 may send user input to media system 14 through path 20 that directs media system 14 to scroll a highlight region through the track listings 98 and to select a highlighted track that is to be played by media system 14.

Screens such as the menu screen of FIG. 7, the now playing screen of FIG. 8, and the media item selection list screen of FIG. 9 are merely examples of the types of information that may be displayed by the media system during operation. For example, media system 14 may present different screens or screens with more information (e.g., information on television shows, etc.) than the screens of FIGS. 7, 8, and 9. The screens of FIGS. 7, 8, and 9 are merely illustrative.

The gesture capabilities of user device 12 may be used when implementing the remote control operation in user device 12. For example, device 12 may contain hardware and/or software that recognizes when the user makes an upward gesture on the touch screen of device 12. When this gesture is made, device 12 may direct media system to take an appropriate action. For example, user device 12 may direct media system 14 to increase a volume level associated with one or more hardware and/or software components in media system 14. The volume level that is adjusted in this way may be a television volume, an audio-video receiver volume, a set-top box volume, a personal computer volume, a volume level associated with a now playing screen of the type shown in FIG. 8, a volume level associated with a currently playing media item shown on a media item selection screen of the type shown in FIG. 9.

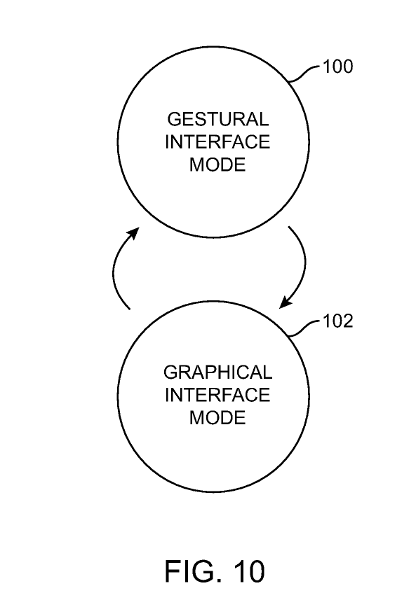

FIG. 10 shows that a handheld electronic device, such as user device 12, may operate in two modes. A first mode may be a gestural interface mode 100. In the gestural interface mode, the gesture recognition capabilities of user device 12 may implement remote control functions that allow a user to control media system 14 through user device 12. For example, the gesture capabilities of user device 12 may allow the user to perform direct remote control functions such as scrolling or otherwise moving a highlight region through selectable media options presented by media system 14 (FIG. 7), controlling playback of an audio (or video) track by media system 14 (FIG. 8), and scrolling through a media item selection list presented by media system 14 (FIG.9).

In a typical scenario, gestural interface mode 100 of user device 12 is used to perform remote control functions while the user's attention is focused on media system 14. For example, when media system 14 presents the now playing screen of FIG. 8, a user may adjust the volume, play, pause, fast forward, rewind, or skip tracks using gestures without needing to focus their attention on user device 12.

In graphical interface mode 102, a second mode of user device 12, the gestural capabilities of user device 12 may be used to allow a user to navigate within a list of media items and other screens on user device 12. A graphical interface of this type may be used to allow a user to browse through lists of media items and others such information. If a user wishes to playback a desired item, the user can make an appropriate media item selection and playback command using the graphical interface. In response, user device 12 can convey a desired remote control command to system 14. In this mode of operation, the user may be considered to be performing indirect remote control operations.

In a typical scenario, graphical interface mode 102 allows a user to remotely control media system 14 while the user's attention is focused more on user device 12 than media system 14. For example, a user may use the graphical interface mode to perform some or all of the remote control functions implemented in gestural interface mode 100 without relying on a display of visual feedback information by media system 14. Additional remote control functions may also be provided for in the graphical interface mode if desired.

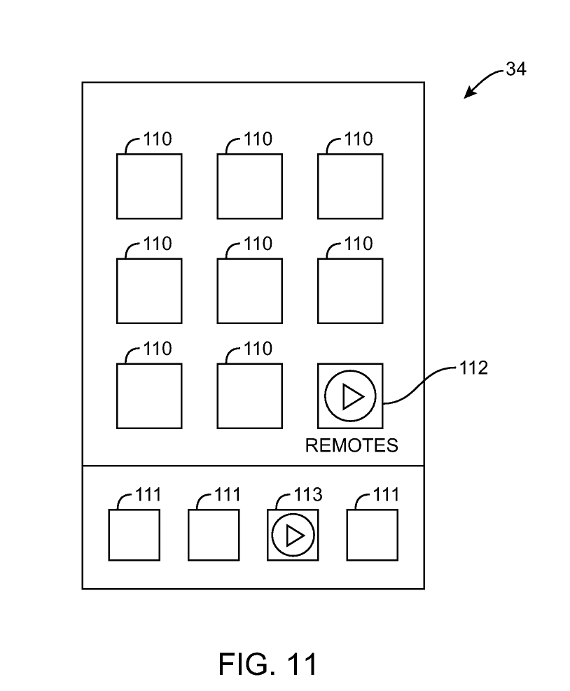

FIG. 11 shows an illustrative homepage display screen associated with software running on user device 12. User device 12 may use the software to present a list of available applications in a screen such as the screen of FIG. 11 as a homepage (i.e., a springboard from which to launch applications). The homepage may be presented by user device 12 during a user's interaction with user device 12 such as when the user device is initialized, unlocked, turned-on, awakened from a power-saving mode, or when an application in user device 12 is closed.

Icons 110 may be selectable icons that represent various applications or functions in user device 12. A selectable icon may be a shortcut that launches an application to perform a desired function in user device 12 (e.g., when a user taps icon 110 on touch screen display 34 to select the icon). Icons 110 may represent applications or functions that are independent of the user device's remote control functions. For example, application icons 110 may launch applications such as a text message editor, web browser, cellular telephone application, voicemail functions, email functions, a user device's media player, global positioning system functions, gaming applications, calendar and scheduling applications, voice recording applications, etc.

Icons 111 may be selectable icons similar to icons 110 that have been identified as favorites. Icons 111 may be automatically selected from the icons 110 that are the most commonly used icons 110 or a user may select which icons 110 to accord favorite status. Icons 111 may be grouped together as shown in the screen of FIG. 11. Alternatively, user device 12 may have a button that is dedicated to launching a favorite application such as a favorite application that is represented by a given one of icons 111.

Icon 112 may be a selectable icon that represents a remote control application in user device 12. Selectable icon 112 may launch a remote control application in user device 12 to perform remote control functions when the icon is selected by a user (e.g., when a user taps icon 112). Alternatively, user device 12 may have a button such as button 37 that is dedicated to launching a remote control application on user device 12.

Icon 113 may be a selectable icon similar to icon 112 that has been selected as a favorite. Icon 113 in its relation to icon 112 has the qualities and features of icons 111 in relation to icons 110. For example, if the remote control application launched with icon 112 is one of the more commonly used applications of icons 110 and icon 112, then icon 113 may be present among the group of favorite icons such as icons 111 and icon 113 at the bottom of the display screen of FIG. 11.

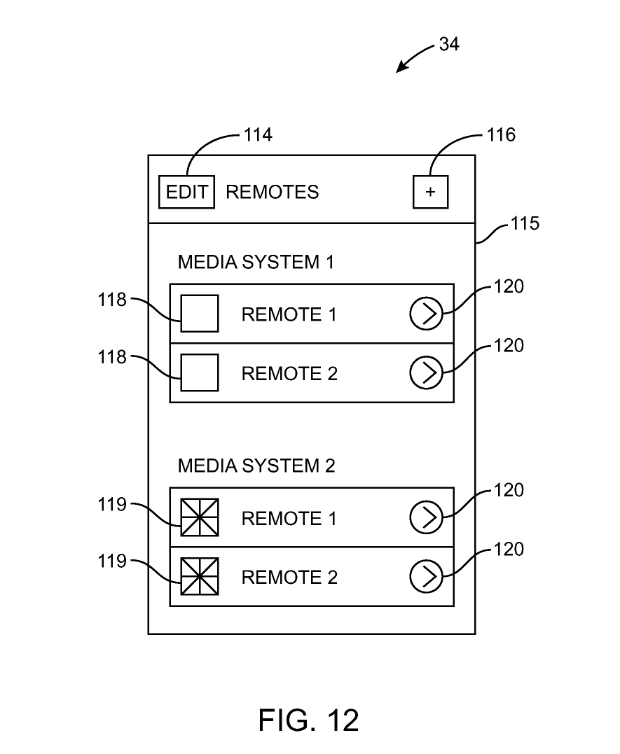

FIG. 12 shows an illustrative media system remotes display screen associated with a remote control application running on user device 12. The illustrative display screen of FIG. 12 may be presented to a user after the remote control application of user device 12 is launched (e.g., after a user selects icon 112 or icon 113 of FIG. 11). The display screen of FIG. 12 may present a selectable list of media system remotes such as selectable list 115. The selectable list of media system remotes may represent the media system remotes that have been selected by an edit process. Alternatively, the selectable list of media system remotes may represent all of the media system remotes currently available to user device 12 (e.g., active media systems with remotes that are within range of communications path 20).

A listed media system remote may represent an individual application or function in a media system 14 that may be remotely controlled. Each media system may have one or more remotes available to user device 12. For example, a personal computer media system may have a media player remote, a slideshow remote, etc.

A selectable on-screen option such as an option presented by icon 114 may initiate an edit process. The edit process may be used to remove media system remotes from selectable list 115 of media system remotes. In a typical scenario, a user may use the edit process initiated by icon 114 to remove media system remotes that are not commonly used by the user from the selectable list.

Add button 116 may be used to initiate a media system remote add process. The add process may be used to select media system remotes (e.g., remote 1 and remote 2 of media system 1 and remote 1 and remote 2 of media system 2) that appear in selectable list 115 of media system remotes. The user may use the add process initiated by button 116 to add available media system remotes to the selectable list of media system remotes.

Indicators 118 and 119 may be provided as part of the selectable icons in selectable list 115 of media system remotes. Indicators such as indicators 118 may show that a media system remote is inactive. Indicators such as indicators 119 may show that a media system remote is active. A media system remote may be active, for example, if there is an ongoing operation such as a media playback operation being performed on media system 14.

When an active media system remote such as remote 1 of media system 2 is selected by a user, the media system remote control application may display the last menu a user accessed in the active media system remote. For example, if the graphical interface in an active media system remote was left in a now playing screen, making a selection to restart the active media system remote may return the user to the now playing screen.

Buttons 120 may be a part of selectable icons in a selectable list such as list 115. Each button may launch a media system remote control application to control a specific media system remote. For example, when a user selects button 120 of remote 1 of media system 1, the remote control application of user device 12 may initiate or resume a remote control connection with media system 1 to enable the user device to remotely control remote 1.

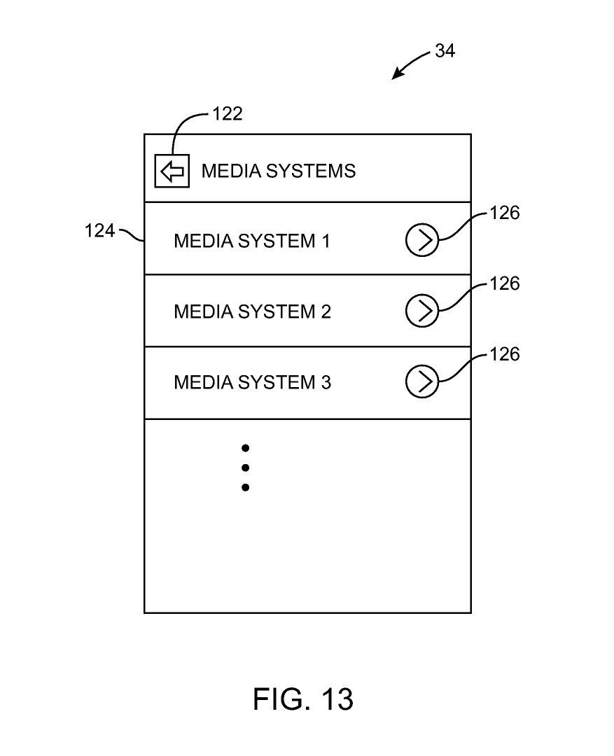

FIG. 13 shows an illustrative display screen associated with a remote control application running on user device 12. The illustrative display screen of FIG. 13 may be presented to a user during an add process to add available media system remotes to a selectable list 115 of FIG. 12.

A user may select button 122 of FIG. 13 to exit the add process. After a user selects button 122, the remote control application may, for example, return to its previous page or may return to the application's homepage such as the homepage of FIG. 11.

List 124 may include a list of media systems 14 that have available media system remotes. Media system remotes may be available when a media system is connected to device 12 through communications path 20 or through communications network 16 and paths 17 and 21.

Buttons 126 may be used to select media systems that are included in list 124. Each button 126 may direct an add process for a remote control application to display a list of available media system remotes for a particular media system. For example, when a user selects button 126 of media system 1 (e.g., by tapping button 126), a list of available media system remotes for media system 14 may appear in a new display screen. If desired, the list of available media system remotes may be displayed under the selected media system and above the following media system.

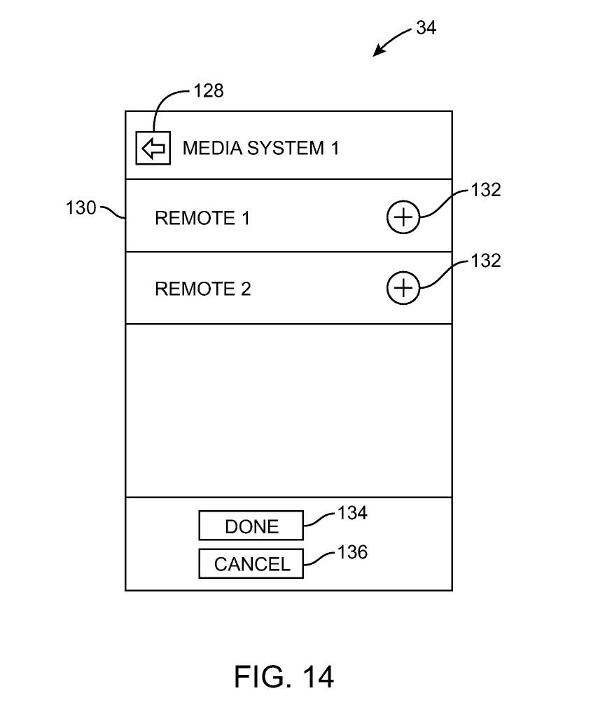

FIG. 14 shows another illustrative media system display screen associated with a remote control application running on user device 12. The illustrative display screen of FIG. 14 may be presented to a user as part of an add process. For example, the display screen of FIG. 14 may be presented when a user selects a media system from the list 124 of FIG. 13.

Button 128 may be selected to return to a previous screen or page of a remote control application. Button 128 may return the remote control application to a list of media systems 14 with available media system remotes such as the display screen of FIG. 13. If desired, the button may return the remote control application to a previous page or to a homepage of user device 12 such as the homepage of FIG. 11.

List 130 may contain a list of media system remotes for a particular media system 14. The list of media system remotes may be displayed as part of an add process to allow a user to add a particular media system remote to a list of media system remotes that form a part of a homepage of a remote control application of user device 12 such as list 115 of FIG. 12.

Buttons 132 may be used to select which media system remote is to be added to list 115 of FIG. 12. Following a user's selection of a given button 132, the user device may remove the selected media system remote from list 130. If desired, the user device may await confirmation of the selection following a user's selection of button 132.

Done button 134 may be selected to confirm the user's selection of which media system remotes are to be added to list 115 of FIG. 12. Cancel button 136 may be used to cancel any of the user's selection of media system remotes to be added to list 115.

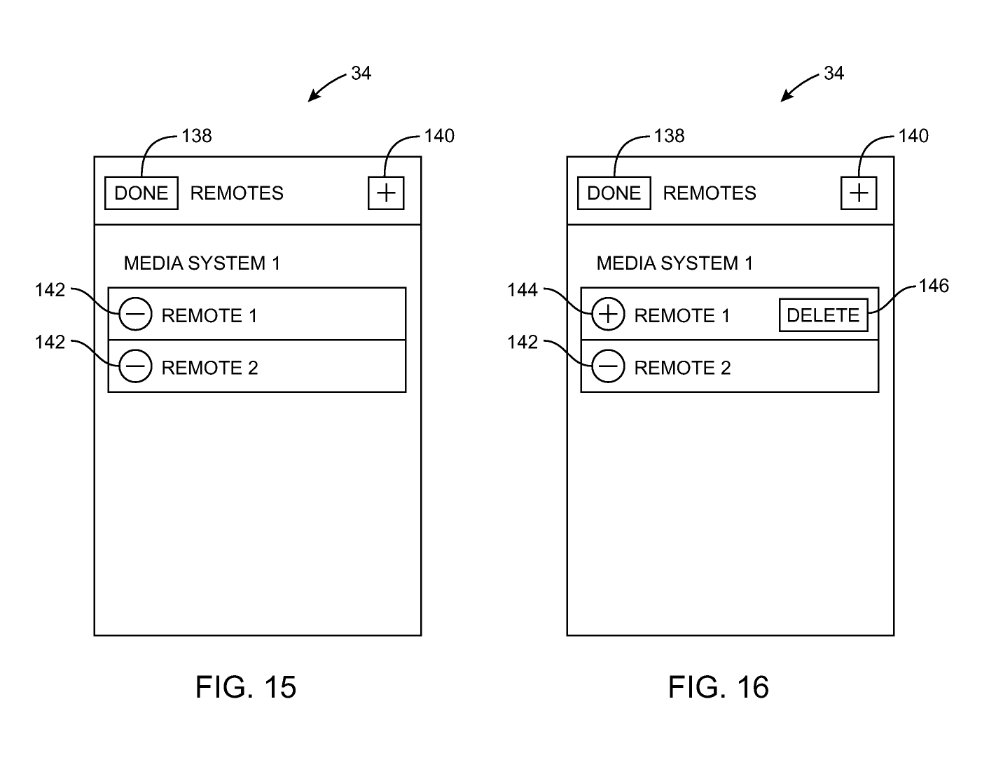

FIG. 15 shows an illustrative media system remote edit process display screen associated with a remote control application running on user device 12 that may be presented to a user as part of an edit process. For example, the display screen of FIG. 15 may be presented when a user selects edit button 114 of FIG. 12. The edit process may be used to remove media system remotes from the list 115 of FIG. 12.

Done button 138 may be selected to exit the edit process. For example, when a user selects button 138, the remote control application of user device 12 may return to a homepage such as the display screen of FIG. 12.

Add button 140 may be selected to exit the edit process and to initiate a media system remote add process such as the add process that begins with the display screen of FIG. 13.

The display screen of FIG. 15 may include a list of media system remotes that are currently a part of the list 115 of FIG. 12. Buttons 142 may be selected as a first step towards removal of a particular media system remote from list 115. For example, after a user selects button 142 for remote 1 of media system 1, the remote 1 of media system 1 may be removed from list 115 and the display screen of FIG. 15. If desired, the edit process may await a confirmation of the user's selection after a user selects button 142.

FIG. 16 shows an illustrative media system edit process display screen that may be presented to a user following a user's selection of media system remotes to be removed from the list 115 (e.g., after a user taps on one or more of buttons 142).

Add buttons 144 may appear after a user selects a given one of buttons 142 to remove a particular media system remote from list 115. For example, if a user had selected button 142 for media system 1 remote 1 and then decided not to remove the media system remote from list 115, the user could select button 144 to cancel the removal of the media system remote.

Delete button 146 may be displayed after a user selects a desired one of buttons 142 to remove a particular media system remote from the list 115. For example, after a user selects a given one of buttons 142 to begin removing a media system from the list 115, the user may select delete button 146 to confirm the user's initial selection of button 142.

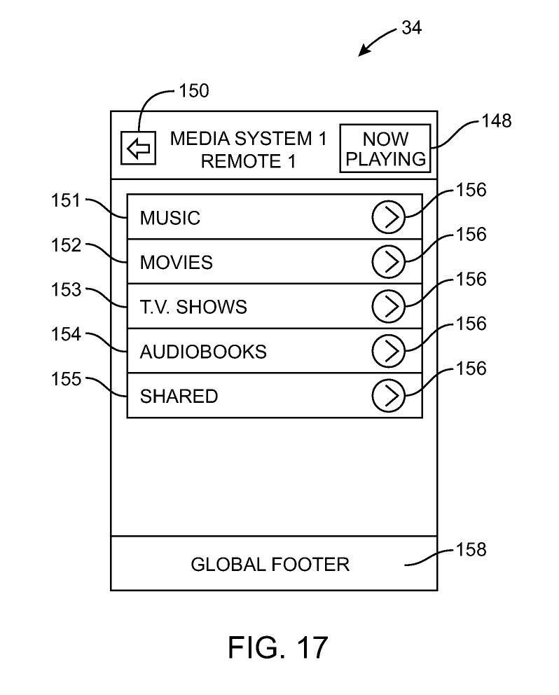

An illustrative media system remote display screen that may be presented by a remote control application when a media system remote is launched is shown in FIG. 17. The display screen of FIG. 17, for example, may be presented when a user selects button 120 to launch remote 1 of media system 1 from a display screen such as the display screen of FIG. 12.

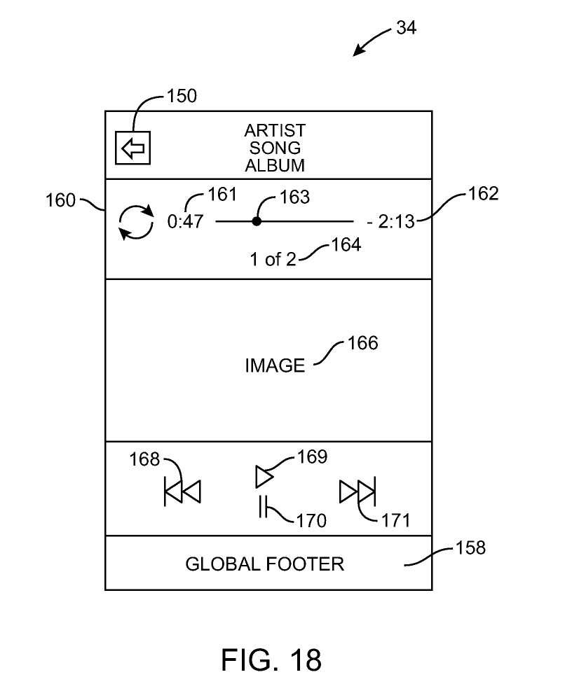

A now playing button such as button 148 may be displayed when a media system is performing a media playback operation. For example, when a media system is performing a video playback operation now playing button 148 may appear to provide the user with a shortcut to a now playing screen such as the now playing screen of FIG. 18.

Back button 150 may be selected to return the user to a previous screen or page of a remote control application in user device 12. The back button may return the remote control application to the list of media system remotes such as list 115 of FIG. 12 or the homepage of user device 12 such as the homepage of FIG. 11. If desired, the back button may return the remote control application to a previous menu in a set of nested menus displayed in the graphical interface mode.

The display screen of FIG. 17 may include a list of selectable media options such as options 151, 152, 153, 154, and 155. The selectable media options may represent an organized selection of media items and menus that is received by user device 12 from media system 14.

A user may select a given one of buttons 156 to select a particular media option or item from a list of selectable media options or items. Following user selection of a particular media option or item with a given button 156, the remote control application on user device 12 may either display a new listing of selectable media options or media items or may display a now playing screen such as the now playing screen of FIG. 18 (as examples).

In a typical scenario, a user may be presented with a sequence of nested menus when device 12 is operated in graphical interface mode 102. The nested menus may be presented using an arrangement of the type illustrated by the display screen of FIG. 17. For example, a first menu may be used to present the user with a listing of various types of media available in a media system (e.g., music, movies, etc.). Following a user's selection of a desired media type, second and subsequent menus may present the user with successively narrower categories or listings of available media within the selected media type. For example, a second menu (e.g., after a selection of the media type) may be used to present the user with a listing of various categories such as playlists, artists, albums, compilations, podcasts, genres, composers, audio books, etc. After selecting a category (e.g., after selecting artists in the music media type), a subsequent menu may be used to present the user with a listing of all of the media items that are available to the media system within the selected category. This is merely an illustrative example of a sequence of nested menus that may be used in a graphical interface mode.

If desired, the list of selectable media options or items may be stored on media system 14 and transmitted to user device 12 during a remote control application operation. Because the nested menu and lists of selectable media options and items may be received from the media system 14, the menu configuration and lists of selectable media options and items may vary between media systems and media system remotes.

A global footer such as global footer 158 may be provided as part of an illustrative display screen 17. The global footer may be displayed on the top menu screen and all of the nested submenus in a set of menus that are nested as described above.

An illustrative media system remote now playing screen that may be associated with a remote control application on user device 12 is shown in FIG. 18. The now playing screen may be displayed on user device 12 while a media playback operation is being performed on media system 14 such as the playback of a song. Global footer 158 may be displayed as part of a now playing display screen such as the display screen of FIG. 18.

Header 160 may contain information from media system 14 about the current state of the media item playback operation in the now playing screen. For example, an icon may be displayed in header 160 that indicates the current playback mode of the media system. An illustrative icon may include two arrows curved towards each other as shown in FIG. 18. This icon may represent a track repeat mode. Other possible modes may include modes such as a track or song repeat, album repeat, global repeat, random, or standard mode.

Counters 161 and 162 may display track information such as the elapsed time and time remaining in a media playback operation. In the FIG. 18 example, the elapsed time is forty-seven seconds and there are two minutes and thirteen seconds remaining in the playback operation.

Counter 163 may visually display the elapsed time and time remaining for a media playback operation. Counter 163 may be a selectable counter. A user may touch the dot depicting the current elapsed time of media playback in counter 162 and drag the dot forwards or backwards to move the media playback position to an earlier or later part in the media item.

Counter 164 may display track information such as the position of the currently playing track in an album. The currently playing media item depicted in FIG. 18 is the first song in an album with two songs.

Image region 166 may include album art or a video (as examples). For example, when the media item for the media playback operation is a song, the image region 166 may include album art. When the media item associated with the media playback operation is a video, an image region 166 may be used to present the video that is being played back. If desired, an image region 166 may expand to cover the full size of display screen 34. This may be particularly beneficial when the media item is a video.

Selectable icons 168, 169, 170, and 171 may allow a user to remotely control a currently playing media playback operation in media system 14. For example, selectable icon 168 may allow a user to skip to a previous track, selectable icon 169 may appear when a track is paused or stopped and may allow a user to play a track, selectable icon 170 may appear when a track is playing and may allow a user to pause a track, and selectable icon 171 may allow a user to skip to the next track. With one arrangement, pause icon 170 may only be displayed while a track is in a play mode and a play icon 169 is only displayed during a paused or stopped playback operation. With another arrangement, the pause icon and the play icon may both be presented simultaneously.

A user may remotely control a media system such as media system 14 using any suitable combination of gestural commands and commands that are supplied by selecting on-screen options displayed on screens containing menus, selectable media items, etc. User device 12 may connect to a media system to retrieve a list of media options such as the list of media options of FIG. 17. The user device may generate a nested menu structure to facilitate a user's navigation through available media playback options and other media system control options. After navigating through the available media options, a user may initiate a media playback operation by selecting a particular media option. During the media playback operation, a now playing screen such as the now playing screen of FIG. 18 may be presented to a user. The now playing screen may allow the user to adjust the configuration of the media system and to remotely control the media playback operation. For example, the now playing screen may have on-screen controls that a user may interact with to adjust a media system parameter such as a volume setting or to remotely control the media playback operation by, for example, pausing the media playback operation.

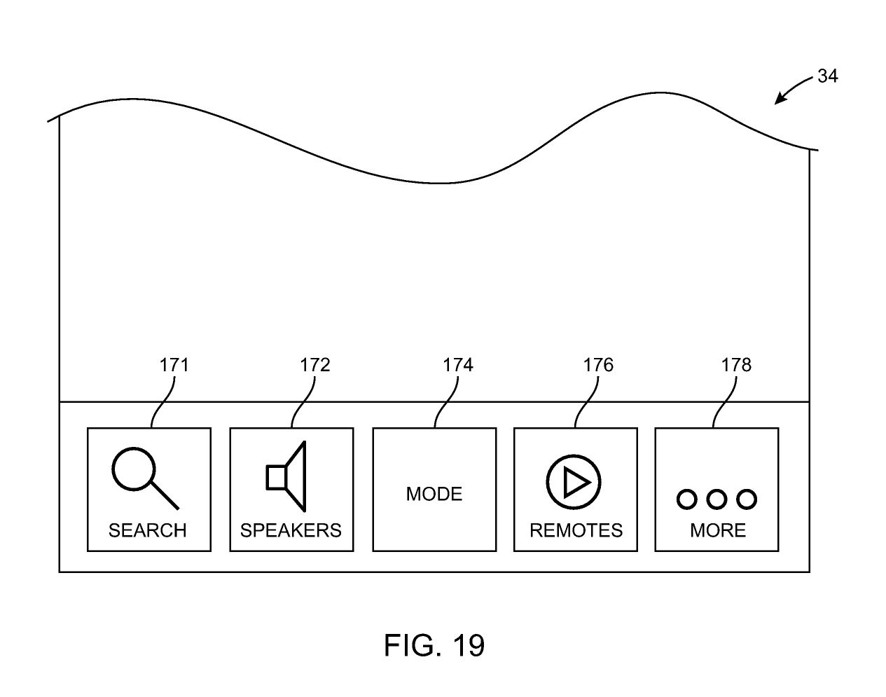

An illustrative global footer that may be displayed by a remote control application is shown in FIG. 19. As shown in FIG. 19, a search icon such as search icon 171 may be selected to open a search page in the remote control application. The search page may allow a user to type in a term using on-screen touch keyboard. The user may then search through the media items available in media system 14.

Speaker icon 172 may be a selectable icon that opens a speaker option page. The speaker option page may allow a user to remotely control the speakers that a media system plays a media item over. For example, media system 14 may have multiple speaker systems that are located in different rooms. In this type of situations, the speaker option page may allow a user to play a media item over one or more particular speaker systems in the media system.

Mode icon 174 may be used to manually override an automatic mode selection that has been made by device 12. For example, if device 12 has automatically entered a graphical interface mode or a gestural interface mode, on-screen mode options 174 may be used to override the automatically selected remote control operating mode.

Remotes icon 176 may be selected to return the remote control application of user device 12 to a homepage. For example, the remote icon may be selected to return the remote control application to the list of media system remotes shown in FIG. 12.

More icon 178 may be selected to open a page that includes advanced options or more shortcuts. For example, the more icon may open a page with equalizer settings, contrast settings, hue settings, etc.

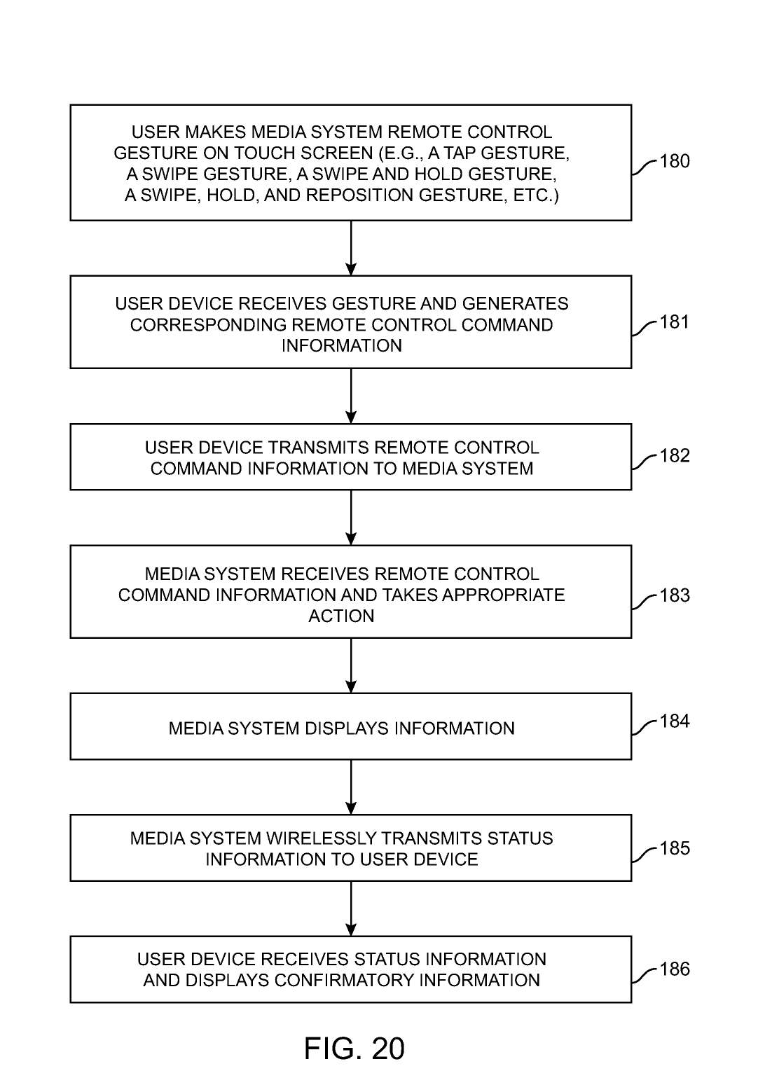

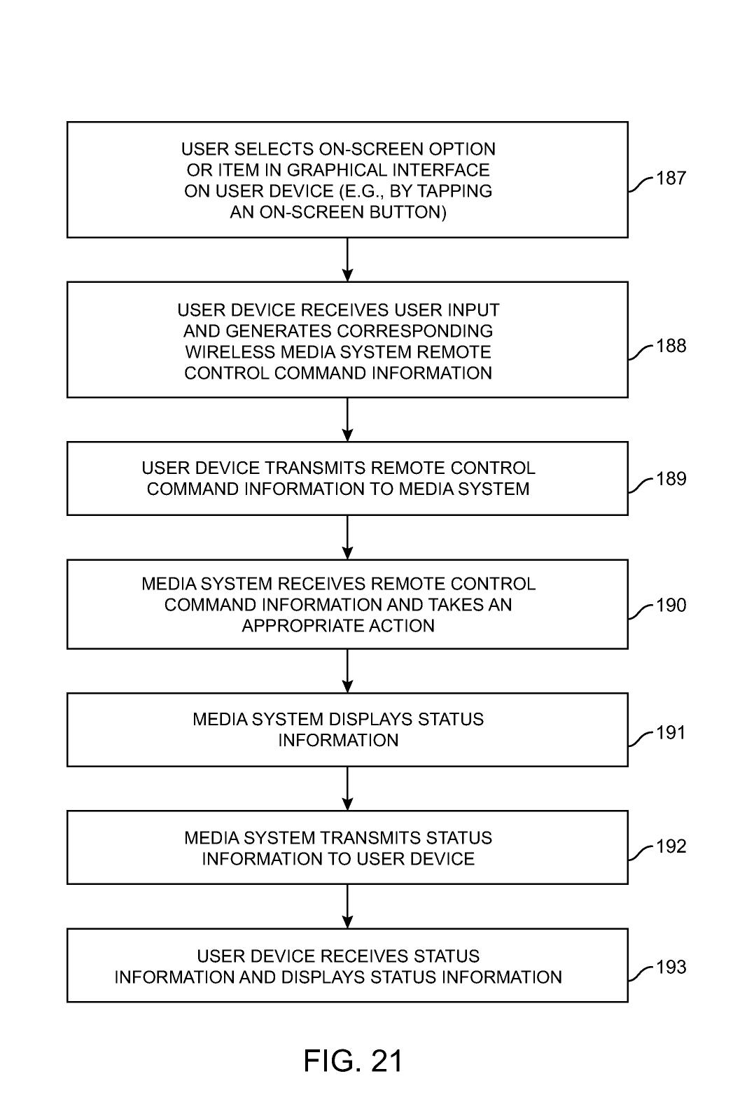

Illustrative steps involved in using a system having a gesture-enabled user device and a media system are shown in FIGS. 20 and 21. The operations of FIG. 20 may be performed when the remote control application on device 12 is operating in a gestural interface remote control operating mode. The operations of FIG. 21 may be performed when the remote control application on deice 12 is operating in a graphical interface (on-screen options) remote control mode of operation.

As shown in FIG. 20, when device 12 is operating in a gestural interface mode such as gestural interface mode 100 (FIG. 10), a user may make a media system remote control gesture on touch screen display 34 of user device 12 at step 180. The gesture may include any suitable motions of one or more fingers (or pens, etc.) on the display. Examples of gestures include single and multiple tap gestures, swipe-based gestures, etc. The media system that is being controlled may have equipment such as a television, set-top box, television tuner equipment (e.g., stand-alone equipment or equipment in a television or set-top box), personal video recorder equipment (e.g., stand-alone equipment or equipment incorporated into a personal computer or cable or satellite set-top box), a personal computer, a streaming media device, etc.

In gestural interface mode 100, a media system remote control gesture may directly control a media system. For example, in the gestural interface mode of user device 12, the media system remote control gesture may directly control a system parameter of the media system. System parameters that may be controlled in this way may include volume levels (of components and media playback applications), display brightness levels, display contrast levels, audio equalization settings such as bass and treble levels, etc. Playback transport settings may also be controlled using gesture commands (e.g., to play, stop, pause, reverse, or fast-forward a media system that is playing a disc or other media or that is playing audio or video on a hard drive or other storage or that is playing audio or video from a streaming source, etc.).

If desired, a highlight region may be moved among an on-screen display of multiple items on the media system. The items that are displayed may be displayed as a list or other suitable group. The displayed items may be displayed using text (e.g., song or video names) or as icons (e.g., graphical menu items). Gestures may be used to navigate among the displayed items and to select items and perform appropriate actions (e.g., play, add to playlist, skip, delete, select, etc.)

At step 181, user device 12 may receive the media system remote control gesture. A processor in user device 12 may be used to process the received gesture to generate corresponding media system remote control command information.

At step 182, remote control command information may be transmitted to media system 14 from user device 12 using any suitable protocol. With one suitable arrangement, wireless communications circuitry in device 12 is used to transmit radio-frequency signals using a local area network protocol such as the IEEE 802.11 protocol (Wi-Fi®). Other protocols that may be used include cellular telephone protocols (e.g., by way of the Internet), the Bluetooth® protocol, or infrared remote control protocols.

At step 183, equipment in media system 14 may receive the remote control command information and take an appropriate action. If, for example, the remote control command includes a swipe command, the media system can increment or decrement a system parameter such as a system (or media playback application) volume, brightness, contrast, audio equalization setting, playback direction or speed, or television channel setting, or can move a highlight region's position within a group of on-screen items (e.g., a list of media items or a group of menu items, etc.). The actions that are taken in the media system in response to the remote control command information may be taken by one or more media system components. For example, in response to a channel up swipe gesture, a television tuner in a television, set-top box, personal computer, or other equipment in system 14 can increment its setting. In response to a volume up swipe, a television, audio-video receiver, or personal computer can adjust an associated volume level setting.

If desired, media system 14 may display status (state) information at step 184 that reflects the current status (state) of the hardware and/or software of system 14. The status information may include, for example, the current level of a volume setting, the current level of an audio equalization setting, the current playback direction and speed of a component in system 14 or a playback application in system 14, etc.

If desired, media system 14 can transmit status (state) information to user device 12 during step 185 in response to received media system remote control command information.

At step 186, user device 12 may receive any such transmitted status information. During step 186, the transmitted status information and other confirmatory information can be displayed for the user on device 12. If desired, the confirmatory information can be displayed on user device 12 in response to reception of the gesture at step 181. This provides a visual confirmation for the user that the gesture has been properly made. Illustrative confirmatory information that may be displayed includes arrows (e.g., to confirm a swipe gesture of a particular direction), transport commands (e.g., play, pause, forward, and reverse including playback speed information), on-screen navigation information (e.g., item up, item down, previous item, next item, or select commands), etc. The confirmatory information that is displayed on user device 12 may be based on the status information that is transmitted from media system 14. For example, the current volume setting or playback transport speed setting that is displayed on user device 12 may be based on status data received from media system 14. User device 12 may or may not display the same or associated status information on a display screen in system 14. For example, if a media playback application is being controlled and a swipe gesture is used to increment a volume setting, user device 12 can display a confirmatory up icon at the same time that media system 14 displays a volume setting graphical indicator on a now playing screen. As another example, when a user makes a gesture to initiate playback of a media item, user device 12 can momentarily display a play icon while media system 14 may display a progress bar (momentarily or persistently).

As shown in FIG. 21, when device 12 is operating in a graphical interface mode such as graphical interface mode 102 (FIG. 10), a user may select an on-screen option or item on touch screen display 34 at step 187. The user may select an on-screen option or item by tapping a button or icon. If desired, the user may select an on-screen option using dedicated buttons on user device 12.

At step 188, user device 12 may receive the user input and generate corresponding remote control command information. A processor in user device 12 may be used to process the received user input to generate corresponding media system remote control command information.

At step 189, the remote control command information may be transmitted to media system 14 from user device 12 using any suitable protocol. With one suitable arrangement, wireless communications circuitry in device 12 is used to transmit radio-frequency signals using a local area network protocol such as the IEEE 802.11 protocol (Wi-Fi®). Other protocols that may be used include cellular telephone protocols (e.g., by way of the Internet), the Bluetooth® protocol, or infrared remote control protocols.

Media system remote control command information may request information from media system 14 or may represent a direct remote control command. For example, the remote control command information may request a list of media options or items from media system 14 or may represent direct remote control command information. Direct remote control command information may directly control a system parameter (e.g., volume, display brightness, etc.) of the media system, may directly control playback transport settings (e.g., to play, stop, pause, reverse, fast-forward), or may direct media system 14 to begin a media item playback operation. These are merely illustrative examples of possible remote control commands that may be generated in graphical interface mode 102.

In graphical interface mode 102 of user device 12, gestures or other user inputs (e.g., on-screen tapping or button presses) may be used to navigate among on-screen options in a graphical interface displayed by the user device. A user input in the graphical interface mode may generate remote control command information. For example, when a user taps on an option to open a nested menu (e.g., by tapping on music option 151 of FIG. 17 to view the music on media system 14) user device 12 may generate corresponding media system remote control command information to retrieve the nested menu (e.g., to retrieve a list of the music on media system 14).

At step 190, equipment in media system 14 may receive the remote control command information and take appropriate action. In the graphical interface mode, the media system's appropriate action may wirelessly transmitting status information to user device 12. The status information may include status information used by the user device to generate appropriate display screen in conjunction with a graphical interface mode. For example, in response to a request for a nested menu the media system may respond by wireless transmitting a new menu or a list of media items to the user device. The media system's appropriate action may include starting a media item playback operation, adjusting a system parameter, or adjusting playback transport settings.

If desired, media system 14 may display status (state) information at step 191 that reflects the current status (state) of the hardware and/or software of system 14. The status information may include, for example, the current level of a volume setting, the current level of an audio equalization setting, the current playback direction and speed of a component in system 14 or a playback application in system 14, etc. The status information may include a menu or list of media items.

At step 192, media system 14 may transmit status (state) information to user device 12 in response to received media system remote control command information.

If desired, user device 12 may generate a new display screen in a graphical interface such as graphical interface 102 on user device 12 in response to reception of transmitted status information at step 193. For example, user device 12 may display a nested submenu that was requested by the media system remote control command information.

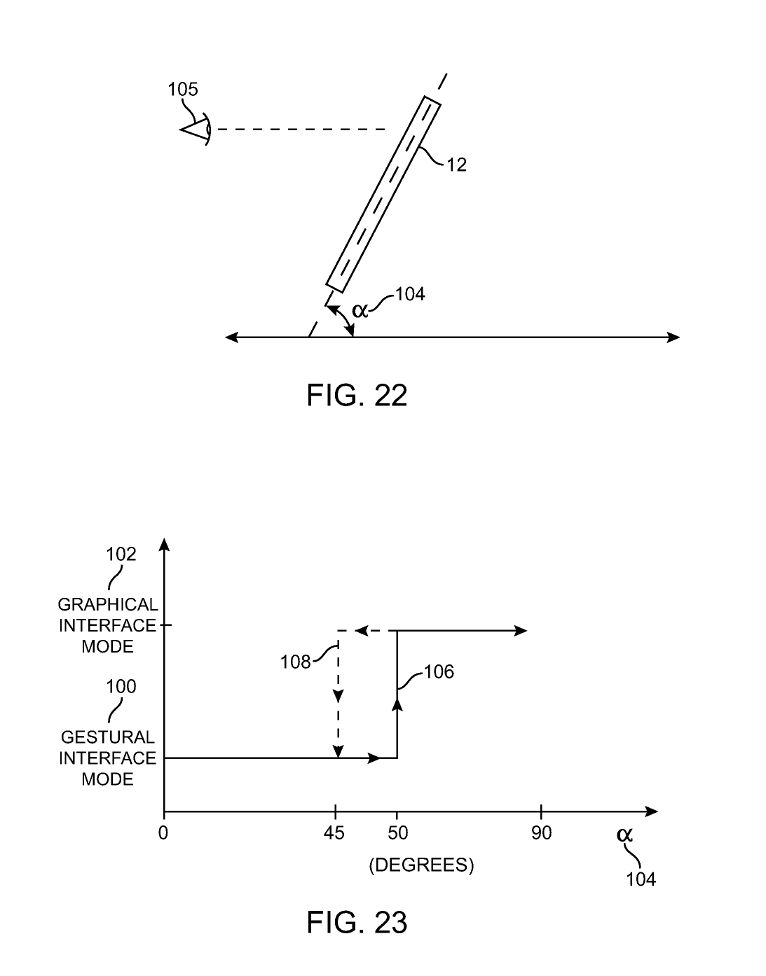

FIG. 22 is a side view of an illustrative user device 12 viewed from the right side of the user device. Eye 105 and the dotted line of FIG. 22 represent the location of a user and the user's line of sight relative to the front of user device 12. Angle 104 (e.g., α), represents the orientation of user device 12 relative to horizontal (i.e., relative to the horizontal ground plane). For example, when user device 12 is resting on a table or other level surface, angle 104 is zero. When user device 12 is held upright, angle 104 is ninety degrees. Angle 104 may be determined in real time using orientation sensing device 55 (FIG. 3).

If desired, a user may switch between gestural interface mode 100 and graphical interface mode 102 by selecting an appropriate on-screen option in user device 12 or by using a dedicated button on user device 12. The transition between the two modes may also occur automatically as a user changes the orientation in which user device 12 is held.

In normal use of device 12, a user may raise or lower device 12 depending on the desired functionality or interface mode for the device. In one example, when a user is trying to change the volume of a movie being played on media system 14, the user may point user device 12 toward media system 14 and perform an input gesture. In pointing the user device toward media system 14, the user may tend to hold the user device close to horizontal (e.g., at an angle that is close to zero degrees). This tendency may be a result of a user's familiarity with conventional remote control devices.

In another example, when user device 12 is to be used in graphical interface mode 102 a user may want to interact with on-screen options in a graphical interface displayed by user device 12 rather than focusing on media system 14. The user may therefore hold the user device in a more vertical fashion (e.g., at an angle that is closer to ninety degrees). Orienting device 12 in this way may enhance the user's ability to view and interact with the display of the user device during graphical interface mode 102.

Once a user becomes accustomed to the automatic remote control mode feature of user device 12, the user may consciously orient the device at an appropriate angle to invoke a desired mode.

A graph showing possible angles at which user device 12 may switch automatically between gestural interface mode 100 and graphical interface mode 102 is shown in FIG. 23. In the arrangement of FIG. 23, the user device switches between its two modes at different angles depending on the previous state of the user device. For example, if the user device is in the gestural interface mode, the user device may be required to be raised to an angle of fifty degrees or more before transitioning to the graphical interface mode (as indicated by the solid line 106). If the user device is in the graphical interface mode, the user device may be required to be lowered to forty-five degrees or less before transitioning to the gestural interface mode (as indicated by the dotted line 108). This optional hysteresis in the mode switching behavior of device 12 may be beneficial in helping to prevent the user device from inadvertently being switched between modes when held near an angle that causes user device 12 to switch modes.

The specific angles of the FIG. 23 example such as fifty degrees and forty-five degrees are merely examples of angles that may be used to switch user device 12 between two remote control interface modes. The angles that define the switching points (e.g., the angles in the graph that lines 106 and 108 appear at) may be any suitable angles. Moreover, remote control device 12 may use orientation sensor 55 to automatically transition between any two desired operating modes. The gestural command interface mode and the graphical interface mode have been described as an example.

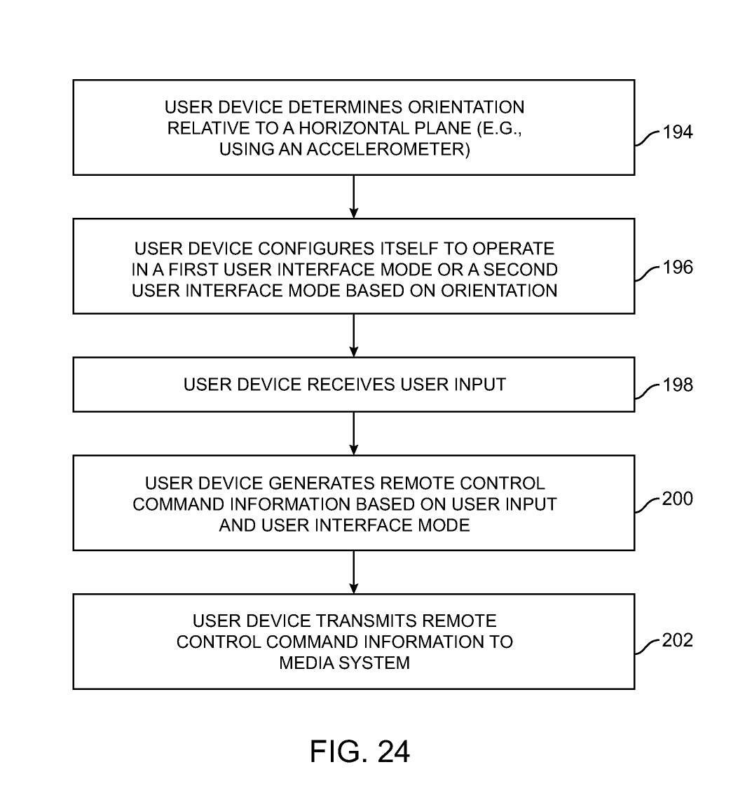

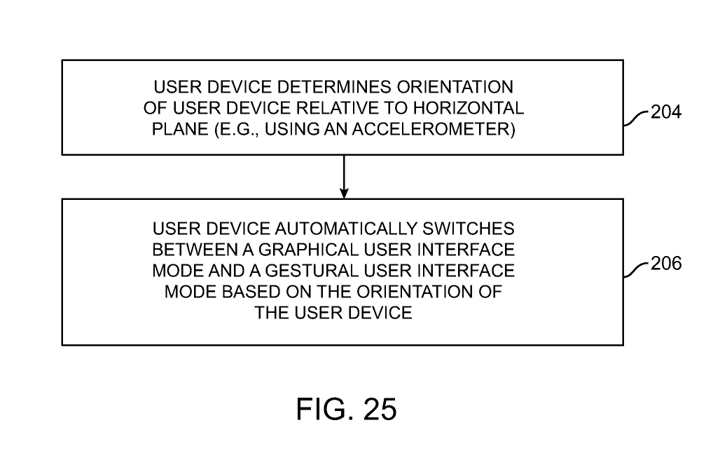

Illustrative steps involved in using a system having a gesture-enabled user device and a media system are shown in FIG. 24.

At step 194, user device 12 may determine the orientation of itself relative to a horizontal plane. User device 12 may determine its orientation using position sensing devices 55 such as an accelerometer that measures the direction of the force of gravity.

At step 196, user device 12 may configure itself to operate in either a first user interface mode or a second user interface mode based on its orientation. For example, user device 12 may configure itself to operate in a graphical interface mode or a gestural interface mode depending on the orientation of the user device relative to the horizontal plane.

At step 198, user device 12 may receive user input. The user input may be gesture based or may be based on user input in a graphical interface displayed on user device 12.

At step 200, user device 12 may generate remote control command information based on the received user input and the configuration of the user device (e.g., the current user interface mode). A processor in user device 12 may be used to process the received user input to generate corresponding media system remote control command information.

At step 202, the remote control command information may be transmitted to media system 14 from user device 12 using any suitable protocol.

Illustrative steps involved in automatically configuring a handheld electronic device with bimodal remote control functionality are shown in FIG. 25.

At step 204, user device 12 may determine the orientation of itself relative to a horizontal plane. User device 12 may determine its orientation using position sensing devices 55 such as an accelerometer that measures the direction of the force of gravity.

At step 206, user device 12 may configure itself to operate in either a graphical user interface mode or a gestural user interface mode based on the orientation of the user device. User device 12 may automatically switch between the graphical user interface mode and the gestural user interface mode as the orientation of the user device is altered by a user (e.g., by a user tilting user device 12 up or down).

The foregoing is merely illustrative of the principles of this invention and various modifications can be made by those skilled in the art without departing from the scope and spirit of the invention.

What is claimed is:

1. A handheld electronic device that remotely controls a media system comprising:
an orientation sensing device that determines the orientation of the handheld electronic device relative to a horizontal plane;
processing circuitry that generates remote control command information for the media system based on user input; and
wireless communications circuitry that transmits the remote control command information to the media system to remotely control the media system.

2. The handheld electronic device defined in claim 1 wherein the wireless communications circuitry is configured to operate in at least one cellular telephone communications band.

3. The handheld electronic device defined in claim 1 wherein the wireless communications circuitry is configured to operate in a local area network radio-frequency communications band and in at least one cellular telephone communications band.

4. The handheld electronic device defined in claim 1 wherein the processing circuitry is configured to implement a media player.

5. The handheld electronic device defined in claim 1 further comprising a touch screen display that receives the user input, wherein the processing circuitry is configured to switch between a first mode of operation and a second mode of operation based on the orientation of the handheld electronic device.

6. The handheld electronic device defined in claim 5 wherein in the first mode of operation the processing circuitry is configured to operate in a graphical interface mode in which the user selects media items for playback by the media system using on-screen options displayed on the touch screen display.

7. The handheld electronic device defined in claim 6 wherein the user input comprises user input generated when the user selects an icon displayed on the touch screen display and wherein in the first mode of operation the processing circuitry is configured to generate the icons that are displayed on the touch screen display.

8. The handheld electronic device defined in claim 5 wherein in the second mode of operation the processing circuitry is configured to operate in a gestural interface mode in which the user controls the media system by making media system remote control gestures on the touch screen display.

9. The handheld electronic device defined in claim 5 wherein in the first mode the processing circuitry generates icons that are displayed on the touch screen display, wherein the user input comprises a user selection of an icon displayed on the touch screen display, and wherein in the second mode the user input comprises a swipe gesture made on the touch screen display.

10. The handheld electronic device defined in claim 5 wherein in the first mode of operation the processing circuitry is configured to operate in a graphical interface mode in which the user selects media items for playback by the media system using on-screen options displayed on the touch screen display, wherein the user input comprises user input generated when the user selects an icon displayed on the touch screen display, wherein in the first mode of operation the processing circuitry is configured to generate the icons that are displayed on the touch screen display, and wherein in the second mode of operation the processing circuitry is configured in a gestural interface mode in which the user controls the media system by making media system remote control gestures including swipe gestures on the touch screen display.

11. The handheld electronic device defined in claim 5 wherein the processing circuitry is configured to switch from the first mode to the second mode when the orientation of the handheld electronic device becomes less than a given angle with respect to the horizontal plane.

12. The handheld electronic device defined in claim 5 wherein the processing circuitry is configured to switch from the second mode to the first mode when the orientation of the handheld electronic device exceeds a given angle with respect to the horizontal plane.

13. A method of remotely controlling a media system with a handheld electronic device that has a touch screen display and wireless communications circuitry, the method comprising:
with an orientation sensor in the handheld electronic device, determining the orientation of the handheld electronic device relative to a horizontal plane;
automatically operating in a first remote control user interface mode or a second remote control user interface mode based on the orientation of the handheld electronic device relative to the horizontal plane;
receiving user input from a user with the touch screen display;
generating remote control command information based on the received user input and based on the remote control user interface mode of the handheld electronic device; and
wirelessly transmitting the remote control command information to the media system with the wireless communications circuitry.

14. The method defined in claim 13 wherein the second remote control user interface mode is a gestural interface mode, the method further comprising converting a user gesture into a remote control command for the media system when in the gestural interface mode.

15. The method defined in claim 13 wherein the first remote control user interface mode is a graphical interface mode, the method further comprising displaying a global footer of options on the touch screen display in the graphical interface mode.

16. The method defined in claim 15 further comprising displaying icons on the touch screen display that may be selected by a user, wherein in the graphical interface mode the user input comprises selection by the user of one of the displayed icons on the touch screen display.

17. The method defined in claim 13 further comprising displaying icons on the touch screen display that may be selected by the user, wherein in the first remote control user interface mode the user input comprises selection by the user of one of the displayed icons on the touch screen display, and wherein in the second remote control user interface mode the user input comprises a swipe gesture made by the user on the touch screen display

18. The method defined in claim 13 further comprising:
switching from the first to the second remote control user interface mode when the orientation of the handheld electronic device relative to the horizontal plane becomes less than a first angle; and
switching from the second to the first remote control user interface mode when the orientation of the handheld electronic device relative to the horizontal plane exceeds a second angle that is larger than the first angle.

19. The method defined in claim 13 further comprising displaying a list of media systems that have available media system remotes, wherein the media system that is being remotely controlled has been selected by a user from the list of media systems that have available media system remotes.

20. A method of remotely controlling a media system with a handheld electronic device that has a touch screen display, an orientation sensor, and wireless communications circuitry, the method comprising:
with the orientation sensor in the handheld electronic device, determining the orientation of the handheld electronic device relative to a horizontal plane; and
automatically switching operation of the handheld electronic device between a graphical remote control user interface mode and a gestural remote control user interface mode based on orientation information from the orientation sensor.

21. The method defined in claim 20 further comprising:
in the gestural remote control user interface mode, receiving a gesture made on the touch screen display, wherein the gesture comprises a swipe gesture.

22. The method defined in claim 20 further comprising:
in the graphical remote control user interface mode, displaying a list of selectable media items on the touch screen display.

23. The method defined in claim 20 further comprising:
in the graphical remote control user interface mode, displaying selectable on-screen menu options.

24. The method defined in claim 20 further comprising:
in the gestural remote control user interface mode, receiving a gesture made on the touch screen display, wherein the gesture comprises a swipe gesture;
displaying a list of selectable media items on the touch screen display; and
displaying selectable on-screen menu options.
